(19) United States
(12) Patent Application Publication
(10) Pub. No.: US 2022/0239165 A1
(43) Pub. Date: Jul. 28, 2022

(54) POSITION DETECTION SYSTEM AND ELECTRIC POWER TRANSMISSION SYSTEM

(71) Applicant: TDK CORPORATION, Tokyo (JP)

(72) Inventor: Daichi MORI, Tokyo (JP)

(73) Assignee: TDK CORPORATION, Tokyo (JP)

(21) Appl. No.: 17/535,814

(22) Filed: Nov. 26, 2021

(30) Foreign Application Priority Data
Jan. 28, 2021 (JP) 2021-011687

(51) Int. Cl. H02J 50/90; H02J 50/12; B60L 53/12; B60L 53/38

(52) U.S. Cl. CPC H02J 50/90; H02J 50/12; H01F 38/14; B60L 53/38; B60L 53/12

(57) ABSTRACT

An antenna is provided in one device from among a power transmission device and a power reception device. A transmission circuit drives the antenna. A plurality of antennas is provided in the other device from among the power transmission device and the power reception device. A radio wave detection circuit detects intensity of a radio wave received by the plurality of antennas. A position detector detects a relative position between the power transmission coil and the power reception coil, based on the intensity detected by the radio wave detection circuit. A transmission circuit drives at least one antenna. The radio wave detection circuit detects intensity of a radio wave being transmitted from an antenna driven by the transmission circuit and being received by an antenna other than the antenna driven by the transmission circuit.

### CROSS-REFERENCE TO RELATED APPLICATION

This application claims the benefit of Japanese Patent Application No. 2021-11687, filed on Jan. 28, 2021, the entire disclosure of which is incorporated by reference herein.

### FIELD

This application relates generally to a position detection system and an electric power transmission system.

### BACKGROUND

A wireless electric power transmission technology for wirelessly transmitting electric power has been receiving attention. The wireless electric power transmission technology can wirelessly transmit electric power from a power transmission device to a power reception device, and therefore application of the technology to various products such as transportation equipment such as an electric train and an electric vehicle, a home appliance, wireless communication equipment, and a toy is expected. A power transmission coil and a power reception coil coupled to each other by magnetic flux are used for transmission of electric power in the wireless electric power transmission technology.

In order to efficiently transmit electric power, a coil axis of the power transmission coil needs to be precisely aligned with a coil axis of the power reception coil. In order to precisely align the coil axes, a relative position between the power transmission coil and the power reception coil needs to be precisely detected. Unexamined Japanese Patent Application Publication No. 2020-198689 describes a technology for detecting a relative position between a power transmission coil and a power reception coil by using a radio wave in the low frequency (LF) band.

In the technology described in Unexamined Japanese Patent Application Publication No. 2020-198689, a relative position between the power transmission coil and the power reception coil is detected based on intensity of a radio wave acquired for each combination of a transmission antenna and a reception antenna at the time of detection of the relative position and predetermined reference data. The reference data are data indicating, for each combination of a transmission antenna and a reception antenna, a reference of a correspondence between a relative position between the power transmission coil and the power reception coil, and intensity of a radio wave received by the reception antenna. For example, the reference data are acquired by using a reference position detection system before executing detection of a relative position. The reference position detection system is basically a position detection system similar to a position detection system used for detection of a relative position.

### SUMMARY

In order to precisely detect a relative position by using the reference data, a difference in the antenna characteristics of antennas including the transmission antenna and the reception antenna is required not to exist between the time of acquisition of the reference data and the time of detection of the relative position. However, the antenna characteristic of an antenna used when the reference data are acquired may differ from the antenna characteristic of an antenna used for detection of a relative position due to individual differences between antenna characteristics caused in a manufacturing process of antennas, a change in an environment around the antennas, and the like.

Therefore, calibration is preferably executed when a relative position is detected, in order to align the antenna characteristic of the antenna used for detection of the relative position with the antenna characteristic of the antenna used when the reference data are acquired. However, the technology described in Unexamined Japanese Patent Application Publication No. 2020-198689 does not have a mechanism for achieving such calibration and therefore may not precisely detect a relative position. Therefore, a position detection system precisely detecting a relative position between a power transmission coil and a power reception coil in wireless electric power transmission is desired.

The present disclosure has been made in view of the aforementioned problem, and an objective of the present disclosure is to precisely detect a relative position between a power transmission coil and a power reception coil in wireless electric power transmission.

In order to solve the aforementioned problem, a position detection system according to an embodiment of the present disclosure

is a position detection system for an electric power transmission system wirelessly transmitting electric power from a power transmission coil included in a power transmission device to a power reception coil included in a power reception device and includes:

at least one first antenna provided in one device from among the power transmission device and the power reception device;

a first transmission circuit driving the at least one first antenna;

a plurality of second antennas provided in the other device from among the power transmission device and the power reception device;

a radio wave detection circuit detecting intensity of a radio wave received by the plurality of second antennas;

a position detector detecting a relative position between the power transmission coil and the power reception coil, based on the intensity detected by the radio wave detection circuit; and

a second transmission circuit driving at least one second antenna from among the plurality of second antennas,

wherein the radio wave detection circuit detects intensity of a radio wave being transmitted from a second antenna driven by the second transmission circuit from among the plurality of second antennas and being received by another second antenna being a second antenna other than the second antenna driven by the second transmission circuit from among the plurality of second antennas.

The aforementioned configuration can precisely detect a relative position between a power transmission coil and a power reception coil in wireless electric power transmission.

### BRIEF DESCRIPTION OF THE DRAWINGS

A more complete understanding of this application can be obtained when the following detailed description is considered in conjunction with the following drawings, in which:

FIG. 1 is a schematic configuration diagram of an electric power transmission system according to Embodiment 1;

FIG. 2 is a perspective view of a power transmission coil unit and a power reception coil unit according to Embodiment 1;

FIG. 3 is a placement diagram of components included in a position detection system according to Embodiment 1;

FIG. 4 is a circuit diagram of the position detection system according to Embodiment 1;

FIG. 5 is a configuration diagram of the position detection system according to Embodiment 1;

FIG. 6 is a graph illustrating a frequency characteristic of an RLC parallel resonant circuit;

FIG. 7 is a graph illustrating a frequency characteristic of an LC series resonant circuit;

FIG. 8 is a first graph illustrating a correspondence between difference voltage and VCr;

FIG. 9 is a second graph illustrating a correspondence between difference voltage and VCr;

FIG. 10 is a graph illustrating a correspondence between difference voltage and VRr;

FIG. 11 is a flowchart illustrating antenna calibration processing executed by the position detection system according to Embodiment 1;

FIG. 12 is a flowchart illustrating first calibration processing in FIG. 11;

FIG. 13 is a flowchart illustrating second calibration processing in FIG. 11;

FIG. 14 is a placement diagram of a transmission antenna and a reception antenna according to Embodiment 2;

FIG. 15 is a circuit diagram of a position detection system according to Embodiment 2;

FIG. 16 is a configuration diagram of the position detection system according to Embodiment 2;

FIG. 17 is a flowchart illustrating antenna calibration processing executed by the position detection system according to Embodiment 2;

FIG. 18 is a flowchart illustrating third calibration processing in FIG. 17; and

FIG. 19 is a flowchart illustrating fourth calibration processing in FIG. 17.

### DETAILED DESCRIPTION

Electric power transmission systems according to embodiments of a technology according to the present disclosure will be described below referring to drawings. Note that, in the following embodiments, the same components are given the same sign. Further, the ratio in size between components and the shapes of the components that are illustrated in each diagram are not necessarily the same as those in implementation.

### Embodiment 1

An electric power transmission system according to the present embodiment can be used for charging secondary batteries in various devices such as an electric vehicle (EV), mobile equipment such as a smartphone, and industrial equipment. An example of the electric power transmission system executing charging of a storage battery in an EV will be described below.

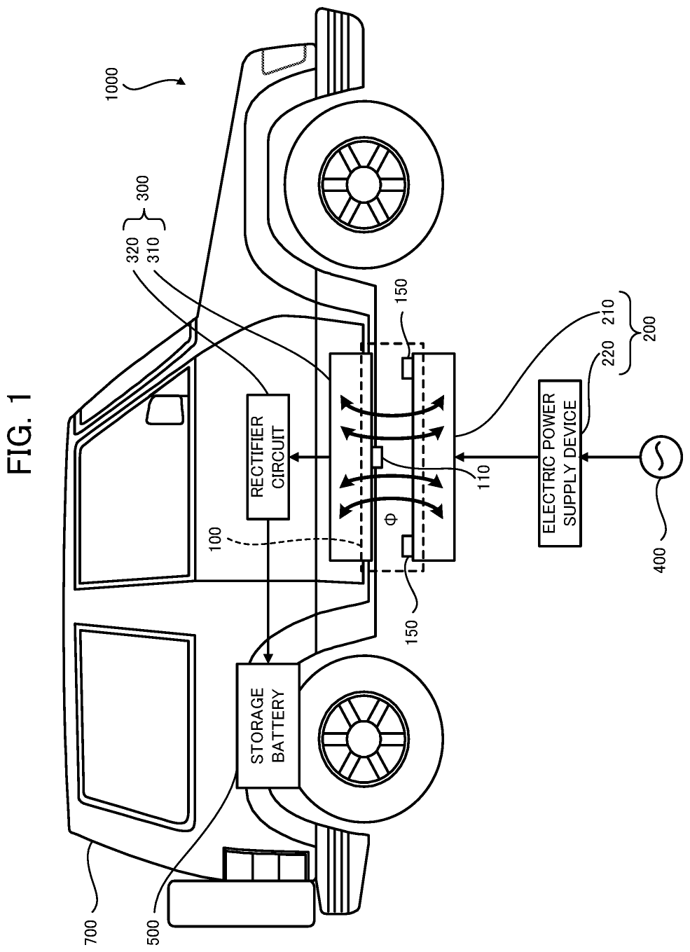

FIG. 1 is a diagram illustrating a schematic configuration of an electric power transmission system 1000 used for charging of a storage battery 500 included in an electric vehicle 700. The electric vehicle 700 travels with a motor driven by electric power charged in the storage battery 500 such as a lithium-ion battery or a lead storage battery as a power source. The electric vehicle 700 is an example of a movable body.

As illustrated in FIG. 1, the electric power transmission system 1000 is a system wirelessly transmitting electric power from a power transmission device 200 to a power reception device 300 by magnetic coupling. The electric power transmission system 1000 includes a position detection system 100 detecting a relative position between a power transmission coil and a power reception coil, a power transmission device 200 wirelessly transmitting electric power of an alternating-current (AC) or direct-current (DC) commercial power source 400 to the electric vehicle 700, and a power reception device 300 receiving the electric power transmitted by the power transmission device 200 and charging the storage battery 500. Note that the commercial power source 400 is an AC power source in the following description. Further, details of the position detection system 100 will be described later.

The power transmission device 200 is a device wirelessly transmitting electric power to the power reception device 300 by magnetic coupling. The power transmission device 200 includes a power transmission coil unit 210 transmitting AC power to the electric vehicle 700 and an electric power supply device 220 supplying AC power to the power transmission coil unit 210.

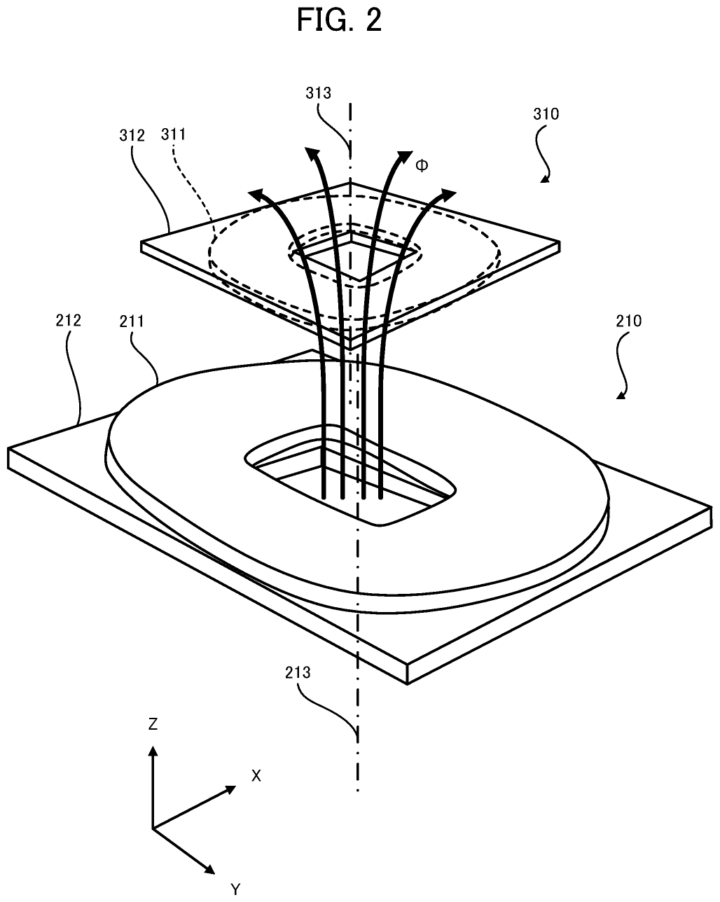

FIG. 2 illustrates main parts of the power transmission coil unit 210 and main parts of a power reception coil unit 310. As illustrated in FIG. 2, the power transmission coil unit 210 includes a power transmission coil 211 being supplied with AC power from the electric power supply device 220 and inducing alternating magnetic flux 1, and a magnetic body plate 212 provided for improving the inductance value of the power transmission coil 211. The power transmission coil 211 is formed by spirally winding a conducting wire around a coil axis 213 on the magnetic body plate 212. The power transmission coil 211 and a capacitor provided at each of two ends of the power transmission coil 211 form a resonant circuit and induce alternating magnetic flux Φ by AC current flowing according to application of AC voltage. In FIG. 2, an axis in an upward vertical direction is a Z-axis, an axis orthogonal to the Z-axis is an X-axis, and an axis orthogonal to the Z-axis and the X-axis is a Y-axis.

The magnetic body plate 212 has a plate shape with a hole in the central part and is formed of a magnetic body. For example, the magnetic body plate 212 is a plate-shaped member formed of ferrite being a composite oxide of iron oxide and metal. The magnetic body plate 212 may be formed of an aggregate of a plurality of segmented magnetic bodies, and the plurality of segmented magnetic bodies may be placed in a frame shape having an opening in the central part.

The electric power supply device 220 includes a power factor improvement circuit improving the power factor of commercial AC power supplied by the commercial power source 400 and an inverter circuit generating AC power to be supplied to the power transmission coil 211. The power factor improvement circuit rectifies and boosts AC power generated by the commercial power source 400 and converts the power into DC power having a predetermined voltage value. The inverter circuit converts DC power generated by electric power conversion by the power factor improvement circuit into AC power at a predetermined frequency. For example, the power transmission device 200 is fixed on the floor surface of a parking lot.

The power reception device 300 is a device wirelessly receiving electric power from the power transmission device 200 by magnetic coupling. The power reception device 300 includes the power reception coil unit 310 receiving AC power transmitted by the power transmission device 200 and a power rectifier circuit 320 converting AC power supplied from the reception coil unit 310 into DC power and supplying the DC power to the storage battery 500.

As illustrated in FIG. 2, the power reception coil unit 310 includes a power reception coil 311 inducing an electromotive force according to a change in the alternating magnetic flux 1 induced by the power transmission coil 211, and a magnetic body plate 312 provided for improving the inductance value of the power reception coil 311. The power reception coil 311 is formed by spirally winding a conducting wire around a coil axis 313 on the magnetic body plate 312. The power reception coil 311 and a capacitor provided at each of two ends of the power reception coil 311 forms a resonant circuit.

The power reception coil 311 faces the power transmission coil 211 when the electric vehicle 700 is at a standstill at a preset position. When the power transmission coil 211 induces the alternating magnetic flux 1 by receiving electric power from the electric power supply device 220, an induced electromotive force is induced at the power reception coil 311 by interlinkage of the alternating magnetic flux 1 with the power reception coil 311.

The magnetic body plate 312 is a plate-shaped member with a hole in the central part and is formed of a magnetic body. For example, the magnetic body plate 312 is a plate-shaped member formed of ferrite being a composite oxide of iron oxide and metal. The magnetic body plate 312 may be formed of an aggregate of a plurality of segmented magnetic bodies, and the plurality of segmented magnetic bodies may be placed in a frame shape having an opening in the central part.

The rectifier circuit 320 generates DC power by rectifying an electromotive force induced at the power reception coil 311. The DC power generated by the rectifier circuit 320 is supplied to the storage battery 500. The power reception device 300 may include, between the rectifier circuit 320 and the storage battery 500, a charging circuit converting DC power supplied from the rectifier circuit 320 into DC power suitable for charging the storage battery 500. For example, the power reception device 300 is fixed to the chassis of the electric vehicle 700.

The position detection system 100 is a system detecting a relative position between the power transmission coil 211 included in the power transmission device 200 and the power reception coil 311 included in the power reception device 300. The position detection system 100 is incorporated into the electric power transmission system 1000 and is used for alignment of a coil axis of the power transmission coil 211 with a coil axis of the power reception coil 311. The position detection system 100 detects a relative position between the power transmission coil 211 and the power reception coil 311 by using a radio wave in the LF band. The position detection system 100 is placed in such a way as to be split between the power transmission device 200 and the power reception device 300.

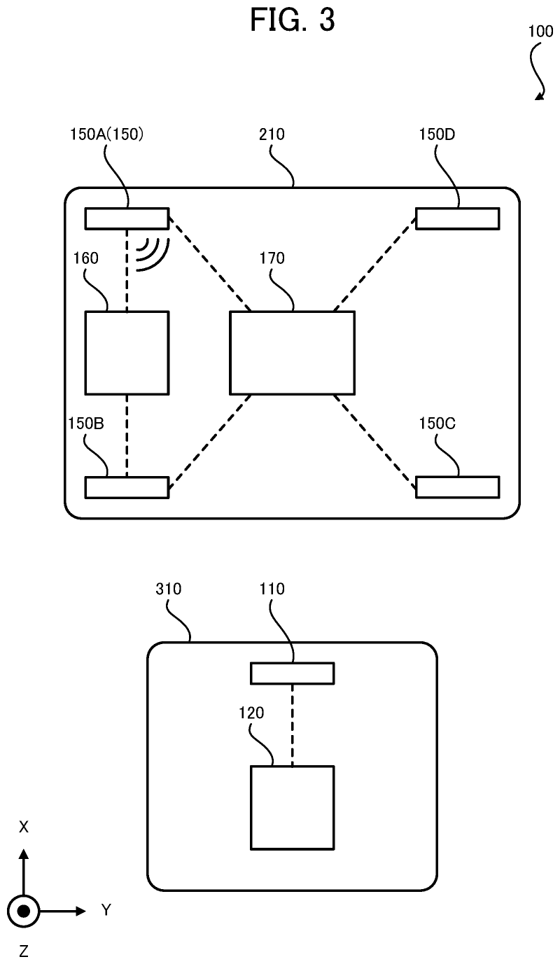

For example, part of components of the position detection system 100 are placed in the power transmission coil unit 210 and the other components of the position detection system 100 are placed in the power reception coil unit 310, as illustrated in FIG. 3. Specifically, an antenna 110 and a transmission circuit 120 are placed in the power reception coil unit 310; and four antennas 150, a transmission circuit 160, and a radio wave detection circuit 170 are placed in the power transmission coil unit 210. The four antennas 150 are placed at four corners of the power transmission coil unit 210 having an almost rectangular shape in a plan view. The antenna 150 is a general name for an antenna 150A, an antenna 150B, an antenna 150C, and an antenna 150D. Note that FIG. 3 illustrates only main components from among the components included in the position detection system 100.

The antenna 110 is an antenna emitting a radio wave in the LF band. The antenna 110 converts a high-frequency signal supplied from the transmission circuit 120 into a radio wave and emits the radio wave. The antenna 110 according to the present embodiment is a coil formed by winding a conducting wire around a bar-shaped magnetic body. While the impedance of the antenna 110 includes resistance, inductive reactance, and capacitive reactance, inductive reactance is dominant. The antenna 110 may be hereinafter referred to as a transmission antenna. The antenna 110 is an example of a first antenna.

The transmission circuit 120 is a circuit feeding electric power to at least one antenna 110 and driving at least one antenna 110. The transmission circuit 120 according to the present embodiment drives one antenna 110. The transmission circuit 120 generates a high-frequency signal from power source voltage and supplies the generated high-frequency signal to the antenna 110. The transmission circuit 120 includes an inverter circuit converting DC power into AC power and is pulse width modulation (PWM) controllable. The transmission circuit 120 includes a capacitive element forming an LC resonant circuit with the antenna 110. The LC resonant circuit according to the present embodiment is an LC series resonant circuit. The frequency characteristic of the LC series resonant circuit may be hereinafter referred to as an antenna characteristic of the antenna 110. The transmission circuit 120 is an example of a first transmission circuit.

The antenna 150 is an antenna for receiving a radio wave in the LF band. The antenna 150 captures a radio wave emitted by the antenna 110, converts the captured radio wave into a high-frequency signal, and supplies the signal to the radio wave detection circuit 170. The antenna 150 is basically formed similarly to the antenna 110. In other words, the antenna 150 is a coil formed by winding a conducting wire around a bar-shaped magnetic body. Further, while the impedance of the antenna 150 includes resistance, inductive reactance, and capacitive reactance, inductive reactance is dominant. The antenna 150 may be hereinafter referred to as a reception antenna. The antenna 150 is an example of a second antenna.

The radio wave detection circuit 170 is a circuit detecting intensity of a radio wave received by a plurality of antennas 150. The radio wave detection circuit 170 outputs voltage related to the amplitude of a high-frequency signal related to a radio wave received by each of the plurality of antennas 150. The radio wave detection circuit 170 includes a second capacitive element and a first resistor forming an RLC resonant circuit with the antenna 150. The RLC resonant circuit according to the present embodiment is an RLC parallel resonant circuit. The frequency characteristic of the RLC parallel resonant circuit may be hereinafter referred to as an antenna characteristic of the antenna 150.

The position detection system 100 detects a relative position between the power transmission coil 211 and the power reception coil 311, based on intensity detected by the radio wave detection circuit 170 and predetermined reference data. The reference data are data indicating, for each combination of the antenna 110 and the antenna 150, a reference of a correspondence between a relative position between the power transmission coil 211 and the power reception coil 311, and intensity of a radio wave received by the antenna 150. For example, the reference data are acquired before detection of a relative position is executed. The reference data are data indicating a map of reference intensity and therefore may be referred to as map data.

In order to precisely detect a relative position by using the reference data, a difference in the antenna characteristics of the antenna 110 and the antenna 150 between the time of acquisition of the reference data and the time of detection of the relative position is required to be nonexistent. However, the antenna characteristics of the antenna 110 and the antenna 150 used when the reference data are acquired may differ from the antenna characteristics of the antenna 110 and the antenna 150 used for detection of the relative position due to individual differences between the antenna characteristics caused in a manufacturing process of the antenna 110 and the antenna 150, a change in an environment around the antenna 110 and the antenna 150, and the like.

Therefore, calibration is executed when a relative position is detected, in order to align the antenna characteristics of the antenna 110 and the antenna 150 used for detection of the relative position with the antenna characteristics of the antenna 110 and the antenna 150 used when the reference data are acquired, according to the present embodiment. In order to achieve such calibration, at least one antenna 150 from among a plurality of antennas 150 being reception antennas can not only receive a radio wave but also transmit a radio wave, according to the present embodiment. Specifically, the position detection system 100 according to the present embodiment includes the transmission circuit 160 driving the at least one antenna 150.

The transmission circuit 160 is a circuit feeding electric power to at least one antenna 150 and driving at least one antenna 150. Antennas 150 driven by the transmission circuit 160 according to the present embodiment are two antennas being the antenna 150A and the antenna 150B. The transmission circuit 160 generates a high-frequency signal from power source voltage and supplies the generated high-frequency signal to the antenna 150. The transmission circuit 160 includes an inverter circuit converting DC power into AC power and is PWM controllable. The transmission circuit 160 includes a first capacitive element forming an LC resonant circuit with the antenna 150. The LC resonant circuit according to the present embodiment is an LC series resonant circuit. The frequency characteristic of the LC series resonant circuit may be hereinafter referred to as an antenna characteristic of the antenna 150. The transmission circuit 160 is an example of a second transmission circuit.

The radio wave detection circuit 170 detects intensity of a radio wave being transmitted from an antenna 150 driven by the transmission circuit 160 from among a plurality of antennas 150 and being received by another antenna 150 being an antenna 150 other than the antenna 150 driven by the transmission circuit 160 from among the plurality of antennas 150. For example, a case of the antenna 150A being driven by the transmission circuit 160 and the antenna 150D receiving a radio wave emitted by the antenna 150A is assumed. In this case, the radio wave detection circuit 170 detects intensity of the radio wave received by the antenna 150D.

The position detection system 100 detects the difference between the intensity of the radio wave received by the antenna 150D and predetermined reference intensity. The reference intensity is intensity to be detected by the radio wave detection circuit 170 when the antenna 150D receives a radio wave emitted by the antenna 150A in a case of the antenna characteristic of the antenna 150A and the antenna characteristic of the antenna 150D being suitable. For example, the reference intensity is acquired when the reference data are acquired, for each combination of an antenna 150 capable of transmitting a radio wave and an antenna 150 capable of receiving the radio wave. Since there are two antennas 150 capable of transmitting a radio wave and three antennas 150 capable of receiving a radio wave, there are six combinations, according to the present embodiment.

A relative position between the four antennas 150 is the same between the time of acquisition of the reference intensity and the time of detection of the relative position. Accordingly, intensity acquired when the relative position is detected is the same as the reference intensity as long as the antenna characteristic of the antenna 150 transmitting a radio wave and the antenna characteristic of the antenna 150 receiving the radio wave are the same between the time of acquisition of the reference intensity and the time of detection of the relative position. In other words, the antenna characteristics at the time of acquisition of the reference intensity are considered to be reproduced by adjusting the antenna characteristic of the antenna 150 transmitting a radio wave and the antenna characteristic of the antenna 150 receiving the radio wave in such a way that intensity acquired when the relative position is detected is the same as the reference intensity.

Therefore, the antenna characteristic of the antenna 150 transmitting a radio wave and the antenna characteristic of the antenna 150 receiving the radio wave are adjusted in such a way that the antenna characteristics at the time of acquisition of the reference intensity are reproduced, according to the present embodiment. Specifically, the frequency characteristic of an LC series resonant circuit including the antenna 150 transmitting a radio wave and the frequency characteristic of an RLC parallel resonant circuit including the antenna 150 receiving the radio wave are adjusted. Details of the adjustment method will be described later.

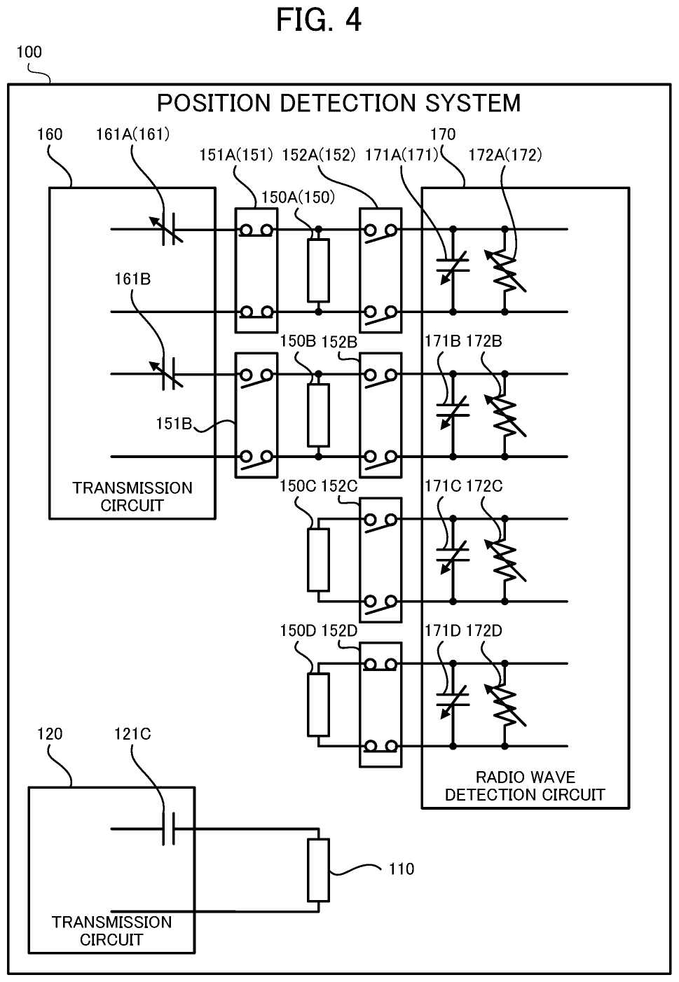

Next, connections between the antenna 150, the transmission circuit 160, and the radio wave detection circuit 170 will be described with reference to a circuit diagram of the position detection system 100 illustrated in FIG. 4. Note that FIG. 4 illustrates a circuit diagram of part of the components included in the position detection system 100. As illustrated in FIG. 4, the position detection system 100 includes two switches 151 and four switches 152. The switch 151 is a general name for a switch 151A and a switch 151B. The switch 152 is a general name for a switch 152A, a switch 152B, a switch 152C, and a switch 152D.

The switches 151 are switches changing a connection between at least one antenna 150 from among a plurality of antennas 150 and the transmission circuit 160. The switch 151A is a switch changing a connection between the antenna 150A and the transmission circuit 160. When the switch 151A is turned on, an LC series resonant circuit is formed by the antenna 150A and a capacitive element 161A included in the transmission circuit 160. The switch 151B is a switch changing a connection between the antenna 150B and the transmission circuit 160. When the switch 151B is turned on, an LC series resonant circuit is formed by the antenna 150B and a capacitive element 161B included in the transmission circuit 160. Each of the capacitive element 161A and the capacitive element 161B is a variable capacitance element having a variable capacitance value. A capacitive element 161 is a general name for the capacitive element 161A and the capacitive element 161B. The capacitive element 161A and the capacitive element 161B are examples of the first capacitive element. The switch 151 is an example of a first switch.

The switches 152 are switches changing connections between a plurality of antennas 150 and the radio wave detection circuit 170. The switch 152A is a switch changing a connection between the antenna 150A and the radio wave detection circuit 170. When the switch 152A is turned on, an RLC parallel resonant circuit is formed by the antenna 150A, and a capacitive element 171A and a resistor 172A that are included in the radio wave detection circuit 170. The switch 152B is a switch changing a connection between the antenna 150B and the radio wave detection circuit 170. When the switch 152B is turned on, an RLC parallel resonant circuit is formed by the antenna 150B, and a capacitive element 171B and a resistor 172B that are included in the radio wave detection circuit 170.

The switch 152C is a switch changing a connection between the antenna 150C and the radio wave detection circuit 170. When the switch 152C is turned on, an RLC parallel resonant circuit is formed by the antenna 150C, and a capacitive element 171C and a resistor 172C that are included in the radio wave detection circuit 170. The switch 152D is a switch changing a connection between the antenna 150D and the radio wave detection circuit 170. When the switch 152D is turned on, an RLC parallel resonant circuit is formed by the antenna 150D, and a capacitive element 171D and a resistor 172D that are included in the radio wave detection circuit 170. The switch 152 is an example of a second switch.

Each of the capacitive element 171A, the capacitive element 171B, the capacitive element 171C, and the capacitive element 171D is a variable capacitance element having a variable capacitance value. Each of the resistor 172A, the resistor 172B, the resistor 172C, and the resistor 172D is a variable resistance element having a variable resistance value. A capacitive element 171 is a general name for the capacitive element 171A, the capacitive element 171B, the capacitive element 171C, and the capacitive element 171D. A resistor 172 is a general name for the resistor 172A, the resistor 172B, the resistor 172C, and the resistor 172D. The capacitive element 171A, the capacitive element 171B, the capacitive element 171C, and the capacitive element 171D are examples of the second capacitive element. The resistor 172A, the resistor 172B, the resistor 172C, and the resistor 172D are examples of the first resistor.

The antenna 110 and the transmission circuit 120 are always connected. Accordingly, an LC series resonant circuit is always formed by the antenna 110 and a capacitive element 121C included in the transmission circuit 120. The capacitive element 121C is a capacitive element having a fixed capacitance value.

When the antenna 150A is connected to the transmission circuit 160, one of the antenna 150B, the antenna 150C, and the antenna 150D is connected to the radio wave detection circuit 170. When the antenna 150B is connected to the transmission circuit 160, one of the antenna 150A, the antenna 150C, and the antenna 150D is connected to the radio wave detection circuit 170. The antenna 150C and the antenna 150D are not connected to the transmission circuit 160. The antenna 150A and the antenna 150B are not simultaneously connected to the transmission circuit 160. The antenna 150A and the antenna 150B are not simultaneously connected to the radio wave detection circuit 170. Each of the antenna 150A and the antenna 150B is not simultaneously connected to both the transmission circuit 160 and the radio wave detection circuit 170.

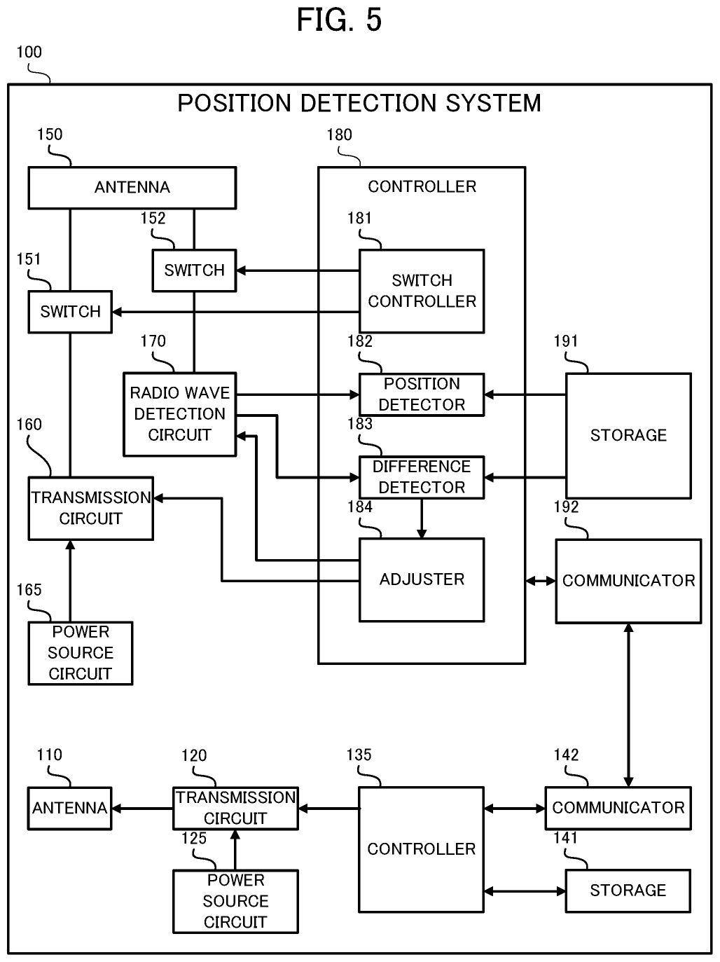

Next, the configuration of the position detection system 100 will be described in detail with reference to FIG. 5. Note that description of a component that has been already described is omitted or simplified. The position detection system 100 includes the antenna 110, the transmission circuit 120, a power source circuit 125, a controller 135, a storage 141, a communicator 142, the antennas 150, the switches 151, the switches 152, the transmission circuit 160, a power source circuit 165, the radio wave detection circuit 170, a controller 180, a storage 191, and a communicator 192.

The antenna 110 emits a radio wave related to a high-frequency signal supplied from the transmission circuit 120. The transmission circuit 120 supplies a high-frequency signal generated from power source voltage to the antenna 110. The power source circuit 125 supplies power source voltage to the transmission circuit 120. The controller 135 controls operation of components placed in the power reception device 300 from among the components included in the position detection system 100. For example, the controller 135 causes the transmission circuit 120 to emit a radio wave from the antenna 110 by controlling the transmission circuit 120. The controller 135 includes a central processing unit (CPU), a read only memory (ROM), a random access memory (RAM), a real time clock (RTC), an analog/digital (A/D) converter, and the like.

The storage 141 stores various types of information used by the controller 135 or various types of information acquired through operation of the controller 135. For example, the storage 141 includes a flash memory. The communicator 142 communicates with the communicator 192 in accordance with control by the controller 135. The communicator 142 includes a communication interface conforming to a well-known wireless communication standard such as Wi-Fi (registered trademark), Bluetooth (registered trademark), Long Term Evolution (LTE), the 4th Generation (4G), or the 5th Generation (5G).

The antenna 150 receives a radio wave emitted by the antenna 110. The switch 151 changes the connection between the antenna 150 and the transmission circuit 160. The switch 152 changes the connection between the antenna 150 and the radio wave detection circuit 170. The transmission circuit 160 supplies a high-frequency signal generated from power source voltage to the antenna 150. The power source circuit 165 supplies power source voltage to the transmission circuit 160. The radio wave detection circuit 170 detects intensity of a radio wave received by the antenna 150.

The controller 180 controls operation of components placed in the power transmission device 200 from among the components included in the position detection system 100. For example, the controller 180 adjusts the antenna characteristic of the antenna 150, based on intensity detected by the radio wave detection circuit 170. The controller 180 includes a CPU, a ROM, a RAM, an RTC, an A/D converter, and the like. Details of the controller 180 will be described later.

The storage 191 stores various types of information used by the controller 180 or various types of information acquired through operation of the controller 180. For example, the storage 191 stores the reference data used for detection of a relative position and the reference intensity used for adjustment of an antenna characteristic. For example, the storage 191 includes a flash memory. The communicator 192 communicates with the communicator 142 in accordance with control by the controller 180. The communicator 192 includes a communication interface conforming to a well-known wireless communication standard, similarly to the communicator 142.

Next, the function of the controller 180 will be described in detail. The controller 180 functionally includes a switch controller 181, a position detector 182, a difference detector 183, and an adjuster 184. For example, the functional units included in the controller 180 are provided by the CPU executing an operation program stored in the ROM.

The switch controller 181 controls the switches 151 and the switches 152. The switch controller 181 controls the switches 152 in such a way as to connect the radio wave detection circuit 170 to an antenna 150 other than an antenna 150 connected to the transmission circuit 160 by the switch 151 from among a plurality of antennas 150.

The position detector 182 detects a relative position between the power transmission coil 211 and the power reception coil 311, based on intensity detected by the radio wave detection circuit 170. For example, the position detector 182 estimates a relative position, based on reference data previously acquired for each of four combinations of one antenna 110 being a transmission antenna and four antennas 150 being reception antennas, and intensity detected by the radio wave detection circuit 170 for each of the four combinations. For example, for each of the four combinations, the position detector 182 specifies a relative position where the difference between intensity based on an intensity distribution indicated by the reference data and detected intensity is small as a candidate position. Then, the position detector 182 specifies a relative position repeatedly specified as a candidate position for each of the four combinations. Alternatively, the position detector 182 retrieves similar coordinates from statistics by using four detected intensity values, based on the reference data. Alternatively, the position detector 182 generates a function acquiring an output for an input from compressed reference data and calculates a relative position by using the function. In the power transmission device 200, positions where the power transmission coil 211 and the antenna 150 are installed, respectively, are predetermined, and a positional relation between the power transmission coil 211 and the antenna 150 is predetermined. Further, in the power reception device 300, positions where the power reception coil 311 and the antenna 110 are installed, respectively, are predetermined, and a positional relation between the power reception coil 311 and the antenna 110 is predetermined. Therefore, when a positional relation between the antenna 110 and the antenna 150 can be specified from detected intensity values, a positional relation between the power transmission device 200 and the power reception device 300 can also be specified.

The difference detector 183 detects the difference between intensity of a radio wave received by another antenna 150 and predetermined reference intensity. The another antenna 150 is an antenna 150 other than an antenna 150 driven by the transmission circuit 160 from among the four antennas 150. The antenna 150 driven by the transmission circuit 160 is the antenna 150A, and the another antenna 150 is the antenna 150D. For example, the reference intensity is intensity of a radio wave being emitted from an antenna 150 placed at the same position as the antenna 150A and being received by an antenna 150 placed at the same position as the antenna 150D when the reference data are acquired. A larger difference detected by the difference detector 183 indicates a larger difference in the antenna characteristic between the time of acquisition of the reference intensity and the time of execution of calibration.

The adjuster 184 adjusts each element in such a way that the difference detected by the difference detector 183 decreases. For example, the adjuster 184 adjusts the frequency characteristic of an RLC parallel resonant circuit including an antenna 150 receiving a radio wave. For example, the adjuster 184 adjusts the capacitance value of a capacitive element 171 included in the RLC parallel resonant circuit in such a way that the aforementioned difference decreases. Further, the adjuster 184 adjusts the resistance value of a resistor 172 included in the RLC parallel resonant circuit in such a way that the aforementioned difference decreases.

Further, for example, the adjuster 184 adjusts the frequency characteristic of an LC series resonant circuit including an antenna 150 transmitting a radio wave. For example, the adjuster 184 adjusts the capacitance value of a capacitive element 161 included in the LC series resonant circuit in such a way that the aforementioned difference decreases. Further, the adjuster 184 adjusts a duty ratio in PWM control of the transmission circuit 160 in such a way that the aforementioned difference decreases. PWM information indicating the duty ratio is transmitted from the communicator 192 to the communicator 142. Then, when a relative position is detected, PWM control of the transmission circuit 120 is executed at the duty ratio indicated by the PWM information in accordance with control by the controller 135.

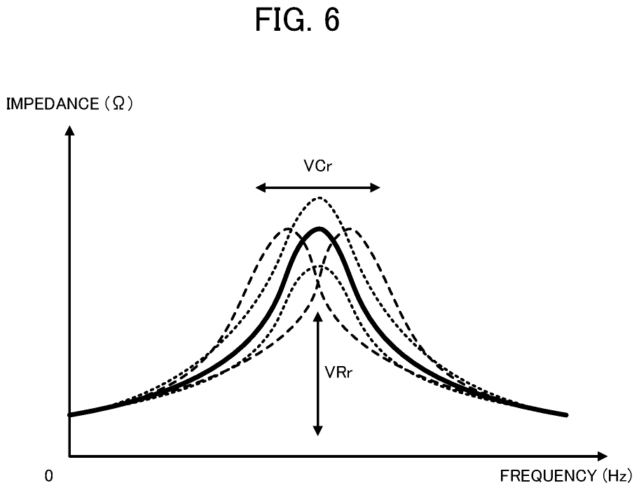

FIG. 6 illustrates a frequency characteristic of an RLC parallel resonant circuit including an antenna 150 receiving a radio wave. In FIG. 6, VCr denotes a capacitance value of a capacitive element 171 included in the RLC parallel resonant circuit, and VRr denotes a resistance value of a resistor 172 included in the RLC parallel resonant circuit. As illustrated in FIG. 6, the resonance frequency of the RLC parallel resonant circuit is adjusted by adjusting the capacitance value of the capacitive element 171. Further, a peak value at the resonance frequency of the RLC parallel resonant circuit is adjusted by adjusting the resistance value of the resistor 172. Intensity of a radio wave received by the antenna 150 is adjusted by adjustment of the resonance frequency of the RLC parallel resonant circuit or the peak value at the resonance frequency of the RLC parallel resonant circuit.

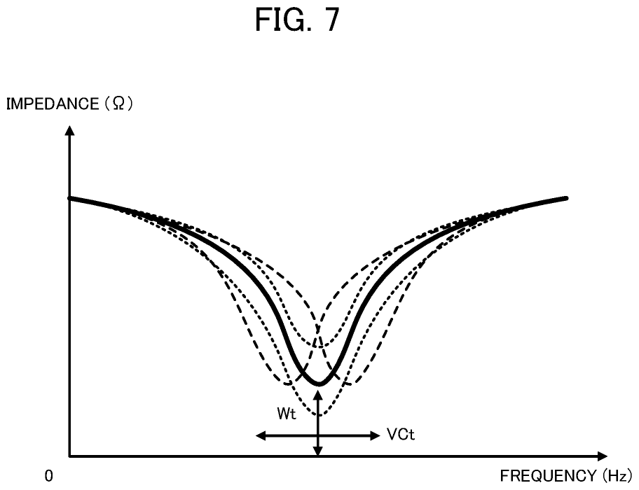

FIG. 7 illustrates a frequency characteristic of an LC series resonant circuit including an antenna 150 transmitting a radio wave. In FIG. 7, VCt denotes a capacitance value of a capacitive element 161 included in the LC series resonant circuit, and Wt denotes a duty ratio in PWM control of the transmission circuit 160. As illustrated in FIG. 7, the resonance frequency of the LC series resonant circuit is adjusted by adjusting the capacitance value of the capacitive element 161. Further, a peak value at the resonance frequency of the LC series resonant circuit is adjusted by adjusting the duty ratio. Intensity of a radio wave transmitted by the antenna 150 is adjusted by adjustment of the resonance frequency of the LC series resonant circuit or the peak value at the resonance frequency of the LC series resonant circuit.

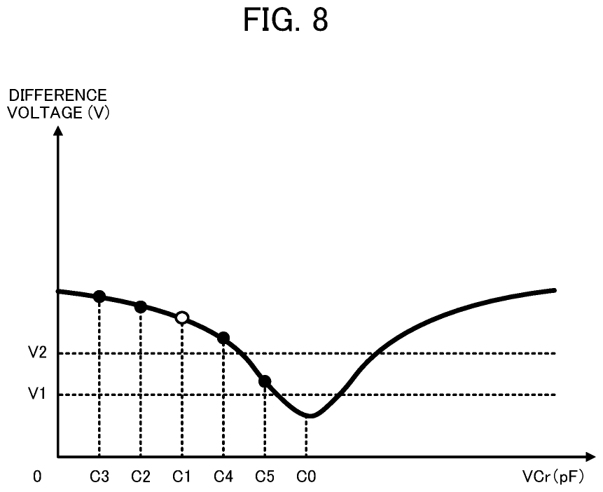

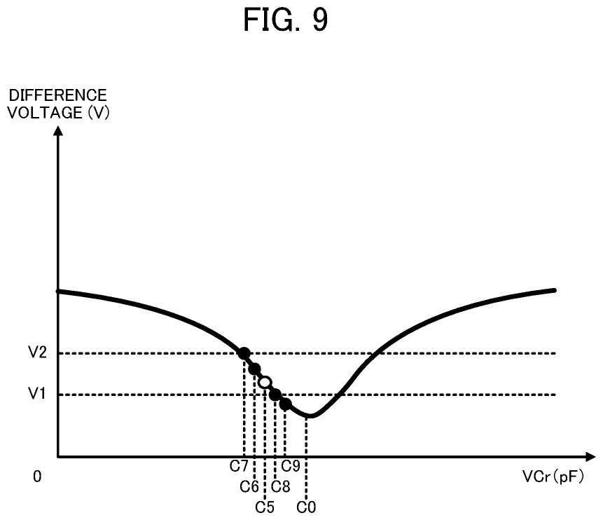

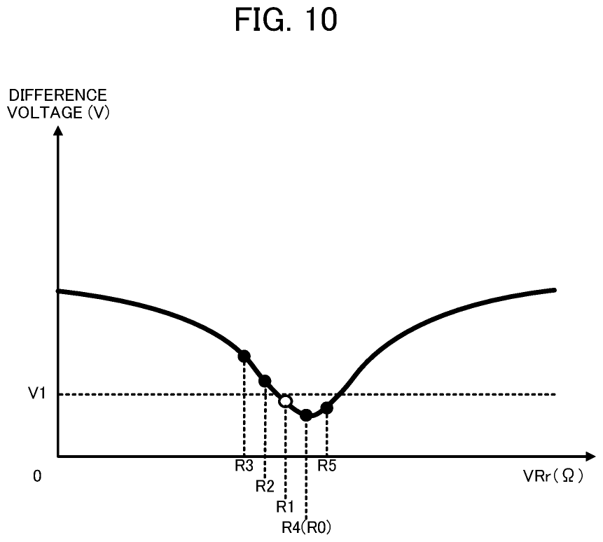

Next, a method of adjusting each element by the adjuster 184 will be described with reference to FIG. 8, FIG. 9, and FIG. 10. FIG. 8 is a first graph illustrating a correspondence between difference voltage and VCr. FIG. 9 is a second graph illustrating a correspondence between difference voltage and VCr. FIG. 10 is a graph illustrating a correspondence between difference voltage and VRr. A main objective of the present embodiment is basically adjustment of the antenna characteristic of an antenna 150 receiving a radio wave. Accordingly, the adjuster 184 mainly adjusts the frequency characteristic of the RLC parallel resonant circuit including the antenna 150 receiving a radio wave.

However, when the antenna characteristic of an antenna 150 transmitting a radio wave is not suitably adjusted, the antenna characteristic of an antenna 150 receiving the radio wave may not be suitably adjusted. Therefore, the adjuster 184 additionally adjusts the frequency characteristic of the LC series resonant circuit including the antenna 150 transmitting a radio wave. Further, the frequency characteristic of an RLC parallel resonant circuit heavily depends on the capacitance value of the capacitive element 171 rather than the resistance value of the resistor 172. Therefore, the adjuster 184 adjusts the resistance value of the resistor 172 after precisely adjusting the capacitance value of the capacitive element 171.

Difference voltage is voltage related to the difference between the reference intensity and intensity detected by the radio wave detection circuit 170 and is voltage related to the difference detected by the difference detector 183. V1 denotes a first threshold value, and V2 denotes a second threshold value. The first threshold value is an upper limit of allowable difference voltage. In other words, when the difference voltage is adjusted to the first threshold value or less, calibration is considered to be suitably executed. The second threshold value is an upper limit of the difference voltage at which a big-step search is changed to a small-step search in a search for VCr minimizing the difference voltage. The second threshold value is a value larger than the first threshold value.

A big-step search has a larger step width being a shift amount of VCr compared with a small-step search. In a big-step search, speed of bringing VCr close to C0 being VCr minimizing the difference voltage is high but precision is low. In a small-step search, speed of bringing VCr close to C0 is low but precision is high. Therefore, the adjuster 184 rapidly brings VCr close to C0 by a big-step search and then precisely brings VCr close to C0 by a small-step search.

FIG. 8 illustrates a scene in which VCr is rapidly brought close to C0 by a big-step search. C1 is the current value of VCr. C2 is a value less than C1 by one first step width being a large step width. C3 a value less than C1 by two first step widths. C4 is a value greater than C1 by one first step width. C5 is a value greater than C1 by two first step widths. The adjuster 184 acquires difference voltage while changing VCr on a per first step width basis with the current value of VCr as a reference. Then, the adjuster 184 employs a value of VCr minimizing the acquired difference voltage as a new value of VCr. The adjuster 184 repeats the big-step search with a newly employed value of VCr as a current value of VCr. When the difference voltage is equal to or less than the second threshold value, the adjuster 184 completes the big-step search. For example, the big-step search is completed at the time point when the value of VCr becomes C5.

FIG. 9 illustrates a scene in which VCr is precisely brought close to C0 by a small-step search. C6 is a value less than C5 by one second step width. The second step width is smaller than the first step width. C7 is a value less than C5 by two second step widths. C8 is a value greater than C5 by one second step width. C9 is a value greater than C5 by two second step widths. The adjuster 184 acquires difference voltage while changing VCr on a per second step width basis with the current value of VCr as a reference. Then, the adjuster 184 employs a value of VCr minimizing the acquired difference voltage as a new value of VCr. The adjuster 184 repeats the small-step search with a newly employed value of VCr as a current value of VCr. When the difference voltage is equal to or less than the first threshold value, the adjuster 184 completes the small-step search. For example, the small-step search is completed at the time point when the value of VCr becomes C9.

FIG. 10 illustrates a scene in which VRr is brought close to R0 by a step search. R0 is VRr minimizing difference voltage when the value of VCr is C9. R1 is a value of VRr after completion of a small-step search. R2 is a value less than R1 by one third step width. The third step width is a shift amount of VRr. R3 is a value less than R1 by two third step widths. R4 is a value greater than R1 by one third step width. R5 is a value greater than R1 by two third step widths. The adjuster 184 acquires difference voltage while changing VRr on a per third step width basis with the current value of VRr as a reference. Then, the adjuster 184 employs a value of VRr minimizing the acquired difference voltage as a new value of VRr. The adjuster 184 repeats the step search with a newly employed value of VRr as a current value of VRr. When the difference voltage becomes a minimum value, the adjuster 184 completes the step search.

When adjustment of the antenna characteristic of the antenna 150 receiving a radio wave is completed, the adjuster 184 adjusts the antenna characteristic of the antenna 150 transmitting a radio wave. In other words, the adjuster 184 adjusts the frequency characteristic of the LC series resonant circuit including the antenna 150 transmitting a radio wave. The adjuster 184 adjusts the frequency characteristic of the LC series resonant circuit by a procedure similar to that for adjustment of the frequency characteristic of the RLC parallel resonant circuit.

Specifically, the adjuster 184 repeats processing of rapidly adjusting VCt by a big-step search until the difference voltage becomes equal to or less than the second threshold value. Then, when the difference voltage becomes equal to or less than the second threshold value, the adjuster 184 repeats processing of precisely adjusting VCt by a small-step search until the difference voltage becomes equal to or less than the first threshold value. When the difference voltage becomes equal to or less than the first threshold value, the adjuster 184 repeats processing of adjusting Wt by a step search until the difference voltage becomes a minimum value.

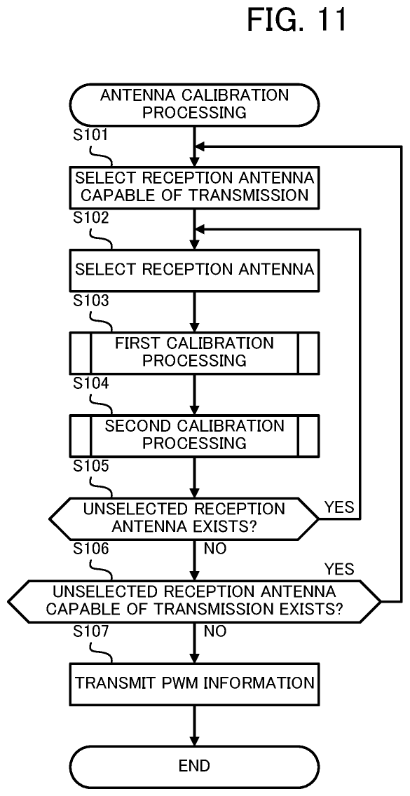

Next, antenna calibration processing executed by the position detection system 100 will be described with reference to FIG. 11. For example, when receiving a start instruction for position detection processing from the power transmission device 200, the position detection system 100 executes the antenna calibration processing prior to the position detection processing. The position detection processing is processing of detecting a relative position between the power transmission coil 211 and the power reception coil 311.

First, the controller 180 included in the position detection system 100 selects a reception antenna capable of transmission (Step S101). For example, the controller 180 selects either antenna 150 of the antenna 150A and the antenna 150B. When completing the processing in Step S101, the controller 180 selects a reception antenna (Step S102). For example, the controller 180 selects one antenna 150 other than the antenna 150 selected in Step S101 from among the four antennas 150.

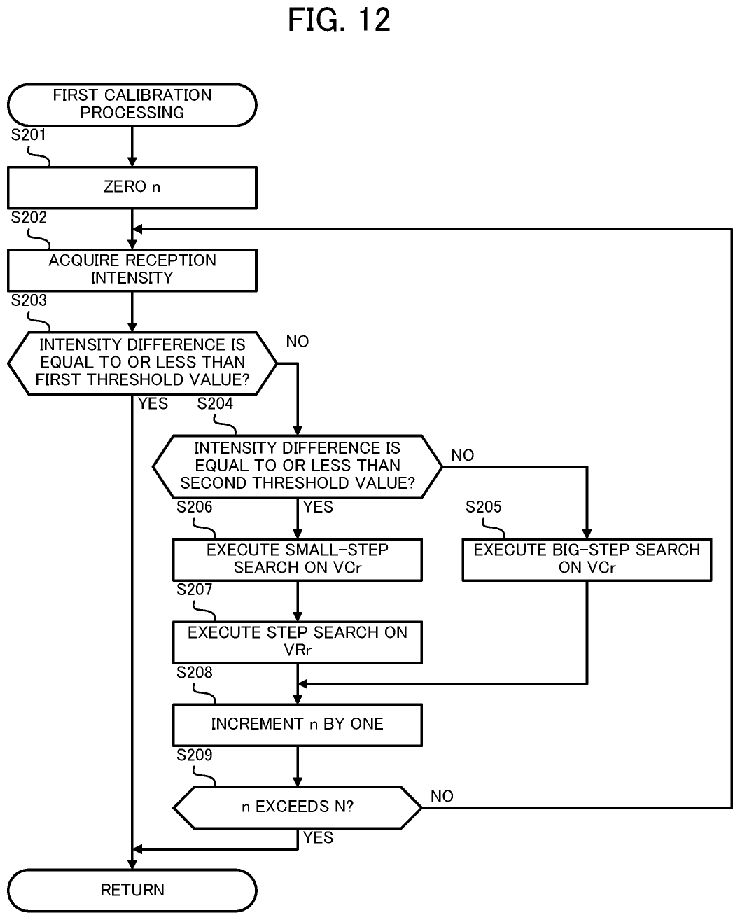

When completing the processing in Step S102, the controller 180 executes first calibration processing (Step S103). The first calibration processing will be described in detail with reference to a flowchart illustrated in FIG. 12. The first calibration processing is processing of adjusting the antenna characteristic of an antenna 150 receiving a radio wave.

First, the controller 180 zeros n (Step S201). Note that n denotes a counter variable for counting the number of repetitions of search processing. When completing the processing in Step S201, the controller 180 acquires reception intensity (Step S202). For example, the controller 180 causes the antenna 150 selected in Step S101 to emit a radio wave and causes the antenna 150 selected in Step S102 to receive the radio wave. The controller 180 acquires reception intensity being intensity of the radio wave received by the antenna 150 from the radio wave detection circuit 170.

When completing the processing in Step S202, the controller 180 determines whether an intensity difference is equal to or less than the first threshold value (Step S203). The intensity difference is the difference between reference intensity being previously acquired and being stored in the storage 191 and the reception intensity acquired in Step S202. When determining that the intensity difference is not equal to or less than the first threshold value (Step S203: NO), the controller 180 determines whether the intensity difference is equal to or less than the second threshold value (Step S204). When determining that the intensity difference is not equal to or less than the second threshold value (Step S203: NO), the controller 180 executes a big-step search on VCr (Step S205). Specifically, the controller 180 searches for VCr minimizing the intensity difference while adjusting VCr on a per first step width basis.

When determining that the intensity difference is equal to or less than the second threshold value (Step S203: YES), the controller 180 executes a small-step search on VCr (Step S206). Specifically, the controller 180 searches for VCr minimizing the intensity difference while adjusting VCr on a per second step width basis. When completing the processing in Step S206, the controller 180 executes a step search on VRr (Step S207). Specifically, the controller 180 searches for VRr minimizing the intensity difference while adjusting VRr on a per third step width basis.

When completing the processing in Step S205 or Step S207, the controller 180 increments n by one (Step S208). When completing the processing in Step S208, the controller 180 determines whether n exceeds N (Step S209). When determining that n does not exceed N (Step S209: NO), the controller 180 returns the processing to Step S202. When determining that the intensity difference is equal to or less than the first threshold value (Step S203: YES) or determining that n exceeds N (Step S209: YES), the controller 180 completes the first calibration processing.

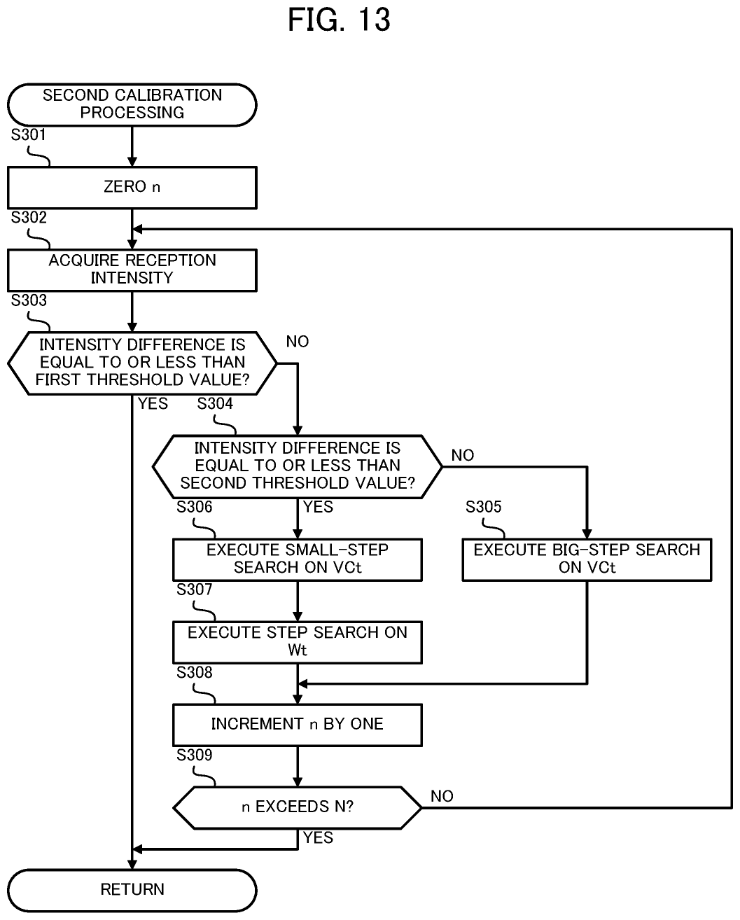

When completing the first calibration processing in Step S103, the controller 180 executes second calibration processing (Step S104). The second calibration processing will be described in detail with reference to a flowchart illustrated in FIG. 13. The second calibration processing is processing of adjusting the antenna characteristic of an antenna 150 transmitting a radio wave.

First, the controller 180 zeros n (Step S301). When completing the processing in Step S301, the controller 180 acquires reception intensity (Step S302). When completing the processing in Step S302, the controller 180 determines whether an intensity difference is equal to or less than the first threshold value (Step S303). When determining that the intensity difference is not equal to or less than the first threshold value (Step S303: NO), the controller 180 determines whether the intensity difference is equal to or less than the second threshold value (Step S304). When determining that the intensity difference is not equal to or less than the second threshold value (Step S303: NO), the controller 180 executes a big-step search on VCt (Step S305). When determining that the intensity difference is equal to or less than the second threshold value (Step S303: YES), the controller 180 executes a small-step search on VCt (Step S306). When completing the processing in Step S306, the controller 180 executes a step search on Wt (Step S307).

When completing the processing in Step S305 or Step S307, the controller 180 increments n by one (Step S308). When completing the processing in Step S308, the controller 180 determines whether n exceeds N (Step S309). When determining that n does not exceed N (Step S309: NO), the controller 180 returns the processing to Step S302. When determining that the intensity difference is equal to or less than the first threshold value (Step S303: YES) or determining that n exceeds N (Step S309: YES), the controller 180 completes the second calibration processing.

When completing the second calibration processing in Step S104, the controller 180 determines whether an unselected reception antenna exists (Step S105). Specifically, the controller 180 determines whether an antenna 150 not being selected in Step S102 and being an antenna 150 other than the antenna 150 selected in Step S101 from among the four antennas 150 exists. When determining that an unselected reception antenna exists (Step S105: YES), the controller 180 returns the processing to Step S102 and selects the unselected reception antenna.

When determining that an unselected reception antenna does not exist (Step S105: NO), the controller 180 determines whether an unselected reception antenna capable of transmission exists (Step S106). Specifically, the controller 180 determines whether an antenna 150 not selected in Step S101 from among the antenna 150A and the antenna 150B exists. When determining that an unselected reception antenna capable of transmission exists (Step S106: YES), the controller 180 returns the processing to Step S101 and selects the unselected reception antenna capable of transmission.

When determining that an unselected reception antenna capable of transmission does not exist (Step S106: NO), the controller 180 transmits PWM information (Step S107). For example, the controller 180 transmits PWM information including Wt finally acquired by the second calibration processing to the communicator 142 through the communicator 192. On the other hand, the controller 135 acquires the PWM information from the communicator 142. In the position detection processing, the controller 135 controls the transmission circuit 120 in such a way that PWM at a duty ratio indicated by the PWM information is executed. When completing the processing in Step S107, the controller 180 completes the antenna calibration processing.

As described above, the transmission circuit 160 driving the antenna 150 being a reception antenna is provided, and intensity of a radio wave being transmitted from a driven antenna 150 and being received by another antenna 150 is detected by the radio wave detection circuit 170, according to the present embodiment. Accordingly, a basis for determination of whether the antenna characteristic of the another antenna 150 is suitable can be acquired, according to the present embodiment. Further, the difference between the intensity of the radio wave received by the another antenna 150 and the predetermined reference intensity is detected, according to the present embodiment. Accordingly, whether the antenna characteristic of the another antenna 150 is suitable can be determined, according to the present embodiment.

Further, the frequency characteristic of an RLC parallel resonant circuit including the another antenna 150 is suitably adjusted by adjustment of the capacitance value of the capacitive element 171 and adjustment of the resistance value of the resistor 172, according to the present embodiment. Accordingly, the antenna characteristic of the another antenna 150 is suitably adjusted, and a relative position between the power transmission coil 211 and the power reception coil 311 can be precisely detected in wireless electric power transmission, according to the present embodiment.

Further, the frequency characteristic of an LC series resonant circuit including the antenna 150 transmitting a radio wave is suitably adjusted by adjustment of the capacitance value of the capacitive element 161 and adjustment of a duty ratio in PWM control, according to the present embodiment. Accordingly, the antenna characteristic of the another antenna 150 is precisely adjusted even when the antenna characteristic of the antenna 150 transmitting a radio wave changes from that at the time of acquisition of the reference data and the reference intensity, according to the present embodiment.

Further, PWM control of the transmission circuit 120 is executed at a duty ratio adjusted in PWM control of the transmission circuit 160, according to the present embodiment. Accordingly, the antenna characteristic of an antenna 110 being a transmission antenna can be suitably adjusted without providing a function of detecting suitability of the antenna characteristic of the antenna 110 on the power reception device 300 side where the antenna 110 is placed, according to the present embodiment.

Further, transmission circuit 160 according to the present embodiment drives two or more antennas 150 from among the four antennas 150. Accordingly, the antenna characteristic of every antenna 150 can be adjusted, according to the present embodiment.

### Embodiment 2

An example of providing the function of transmitting a radio wave for a reception antenna and adjusting antenna characteristics between reception antennas has been described in Embodiment 1. An example of providing a function of receiving a radio wave for a transmission antenna and adjusting antenna characteristics between transmission antennas will be described in the present embodiment. Note that description of a configuration and processing similar to those according to Embodiment 1 is omitted or simplified.

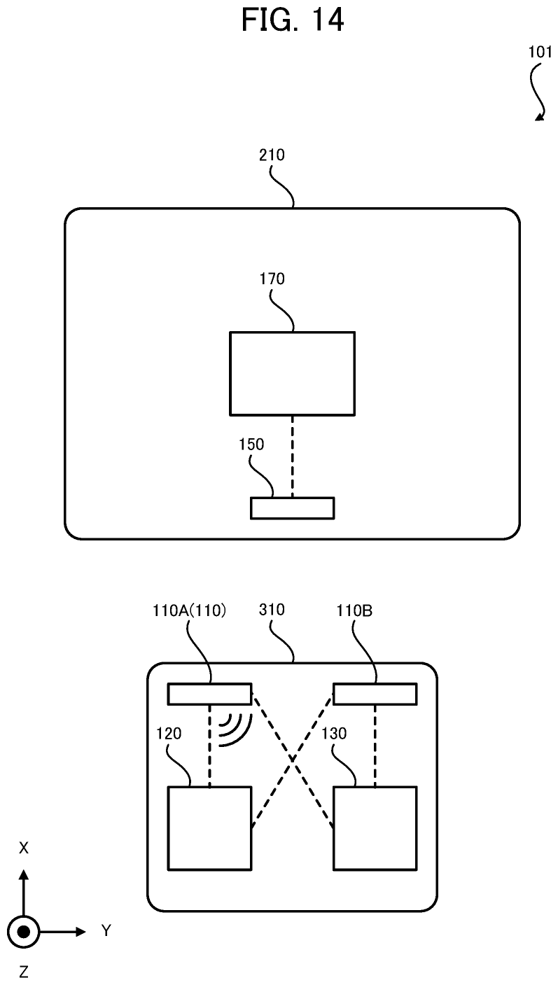

According to the present embodiment, a part of components of a position detection system 101 are placed in a power transmission coil unit 210 and the other components of the position detection system 101 are placed in a power reception coil unit 310, as illustrated in FIG. 14. Specifically, two antennas 110, a transmission circuit 120, and a radio wave detection circuit 130 are placed in the power reception coil unit 310, and an antenna 150 and a radio wave detection circuit 170 are placed in the power transmission coil unit 210. The two antennas 110 are placed at positions distant from each other on the power reception coil unit 310. The antenna 110 is a general name for an antenna 110A and an antenna 110B. Note that FIG. 14 illustrates only main components from among the components included in the position detection system 101.

The antenna 110 is an antenna emitting a radio wave in the LF band. There are two antennas 110, according to the present embodiment. The antenna 110 may be hereinafter referred to as a transmission antenna. The antenna 110 is an example of a second antenna. The transmission circuit 120 is a circuit driving a plurality of antennas 110. The transmission circuit 120 is an example of a transmission circuit. The transmission circuit 120 includes a first capacitive element forming an LC resonant circuit with the antenna 110. The LC resonant circuit according to the present embodiment is an LC series resonant circuit. The frequency characteristic of the LC series resonant circuit may be hereinafter referred to as an antenna characteristic of the antenna 110.

According to the present embodiment, calibration is executed when a relative position is detected, in order to align the antenna characteristic of an antenna 110 used for detection of the relative position with the antenna characteristic of an antenna 110 used when reference data are acquired. In order to achieve such calibration, at least one antenna 110 from among a plurality of antennas 110 being transmission antennas is capable of not only transmitting a radio wave but also receiving a radio wave, according to the present embodiment. Specifically, the position detection system 100 according to the present embodiment includes the radio wave detection circuit 130 detecting intensity of a radio wave received by the at least one antenna 110.

The radio wave detection circuit 130 is a circuit detecting intensity of a radio wave received by at least one antenna 110. For example, the radio wave detection circuit 130 detects intensity of a radio wave being transmitted from the antenna 110A and being received by the antenna 110B. The radio wave detection circuit 130 includes a second capacitive element and a first resistor forming an RLC resonant circuit with the antenna 110. The RLC resonant circuit according to the present embodiment is an RLC parallel resonant circuit. The frequency characteristic of the RLC parallel resonant circuit may be hereinafter referred to as an antenna characteristic of the antenna 110. The radio wave detection circuit 130 is an example of a second radio wave detection circuit.

The position detection system 101 detects the difference between intensity of a radio wave received by the antenna 110B and predetermined reference intensity. The reference intensity is intensity to be detected by the radio wave detection circuit 130 when the antenna 110B receives a radio wave emitted by the antenna 110A in a case of the antenna characteristic of the antenna 110A and the antenna characteristic of the antenna 110B being suitable. For example, the reference intensity is acquired for each combination of a plurality of antennas 110 transmitting a radio wave and an antenna 110 capable of receiving a radio wave when the reference data are acquired. Since there are two antennas 110 transmitting a radio wave and one antenna 110 capable of receiving the radio wave, there are two combinations, according to the present embodiment.

A relative position between the two antennas 110 when the reference intensity is acquired and that when the relative position is detected are the same. Accordingly, intensity acquired when the relative position is detected is the same as the reference intensity as long as the antenna characteristic of the antenna 110 transmitting a radio wave and the antenna characteristic of the antenna 110 receiving the radio wave at the time of acquisition of the reference intensity and those at the time of detection of the relative position are the same. In other words, the antenna characteristic at the time of acquisition of the reference intensity is considered to be reproduced by adjusting the antenna characteristic of the antenna 110 transmitting a radio wave and the antenna characteristic of the antenna 110 receiving the radio wave in such a way that intensity acquired when the relative position is detected and the reference intensity are the same.

Therefore, the antenna characteristic of the antenna 110 transmitting a radio wave and the antenna characteristic of the antenna 110 receiving the radio wave are adjusted in such a way that the antenna characteristics at the time of acquisition of the reference intensity is reproduced, according to the present embodiment. Specifically, the frequency characteristic of an LC series resonant circuit including the antenna 110 transmitting a radio wave and the frequency characteristic of an RLC parallel resonant circuit including the antenna 110 receiving the radio wave are adjusted. Details of the adjustment method will be described later.

The antenna 150 is an antenna receiving a radio wave in the LF band. There is one antenna 150 in the present embodiment. The antenna 150 may be hereinafter referred to as a reception antenna. The antenna 150 is an example of a first antenna. The radio wave detection circuit 170 is a circuit detecting intensity of a radio wave received by at least one antenna 150. The radio wave detection circuit 170 detects intensity of a radio wave received by the antenna 150.

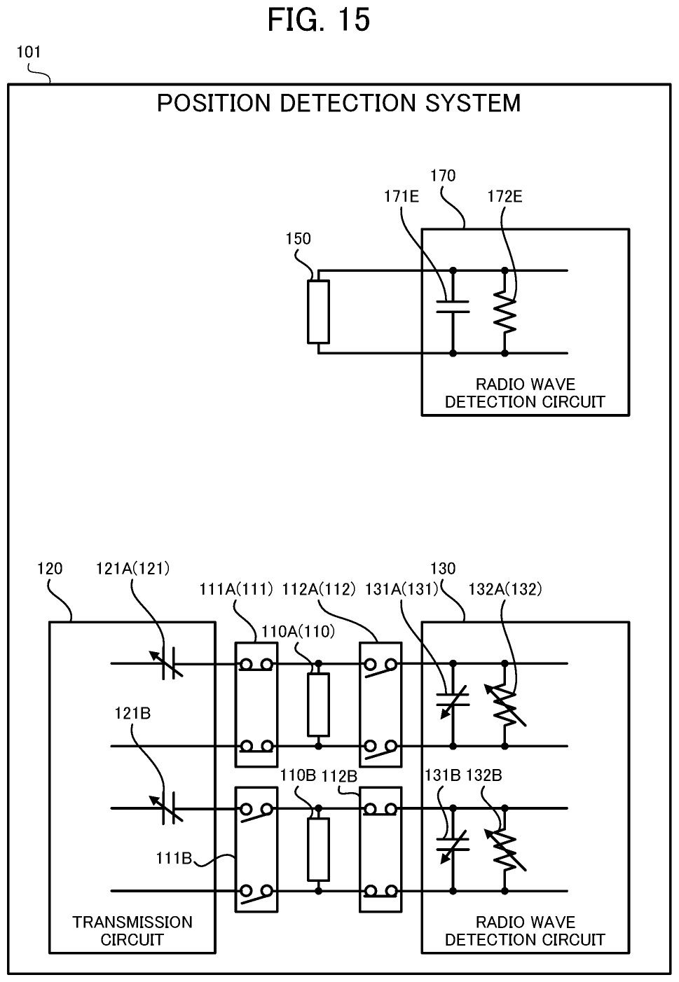

Next, connections between the antenna 110, the transmission circuit 120, and the radio wave detection circuit 130 will be described with reference to a circuit diagram of the position detection system 101 illustrated in FIG. 15. Note that FIG. 15 illustrates a circuit diagram of part of components included in the position detection system 101. As illustrated in FIG. 15, the position detection system 101 includes two switches 111 and two switches 112. The switch 111 is a general name for a switch 111A and a switch 111B. The switch 112 is a general name for a switch 112A and a switch 112B.

The switches 111 are switches changing a connection between at least one antenna 110 from among a plurality of antennas 110 and the transmission circuit 120. The switch 111A is a switch changing a connection between the antenna 110A and the transmission circuit 120. When the switch 111A is turned on, an LC series resonant circuit is formed by the antenna 110A and a capacitive element 121A included in the transmission circuit 120. The switch 111B is a switch changing a connection between the antenna 110B and the transmission circuit 120. When the switch 111B is turned on, an LC series resonant circuit is formed by the antenna 110B and a capacitive element 121B included in the transmission circuit 120. Each of the capacitive element 121A and the capacitive element 121B is a variable capacitance element having a variable capacitance value. The capacitive element 121A and the capacitive element 121B are examples of the first capacitive element.

The switches 112 are switches changing connections between a plurality of antennas 110 and the radio wave detection circuit 130. The switch 112A is a switch changing a connection between the antenna 110A and the radio wave detection circuit 130. When the switch 112A is turned on, an RLC parallel resonant circuit is formed by the antenna 110A, and a capacitive element 131A and a resistor 132A that are included in the radio wave detection circuit 130. The switch 112B is a switch changing a connection between the antenna 110B and the radio wave detection circuit 130. When the switch 112B is turned on, an RLC parallel resonant circuit is formed by the antenna 110B, and a capacitive element 131B and a resistor 132B that are included in the radio wave detection circuit 130.

Each of the capacitive element 131A and the capacitive element 131B is a variable capacitance element having a variable capacitance value. Each of the resistor 132A and the resistor 132B is a variable resistance element having a variable resistance value. A capacitive element 131 is a general name for the capacitive element 131A and the capacitive element 131B. A resistor 132 is a general name for the resistor 132A and the resistor 132B. The capacitive element 131A and the capacitive element 131B are examples of the second capacitive element. The resistor 132A and the resistor 132B are examples of the first resistor.

The antenna 150 and the radio wave detection circuit 170 are always connected. Accordingly, an RLC parallel resonant circuit is always formed by the antenna 150, and a capacitive element 171E and a resistor 172E that are included in the radio wave detection circuit 170. The capacitive element 171E is a capacitive element having a fixed capacitance value. The resistor 172E is a resistance element having a fixed resistance value.

When the antenna 110A is connected to the transmission circuit 120, the antenna 110B is connected to the radio wave detection circuit 130. When the antenna 110B is connected to the transmission circuit 120, the antenna 110A is connected to the radio wave detection circuit 130. The antenna 110A and the antenna 110B are not simultaneously connected to the transmission circuit 120. The antenna 110A and the antenna 110B are not simultaneously connected to the radio wave detection circuit 130. Each of the antenna 110A and the antenna 110B is not simultaneously connected to both the transmission circuit 120 and the radio wave detection circuit 130.

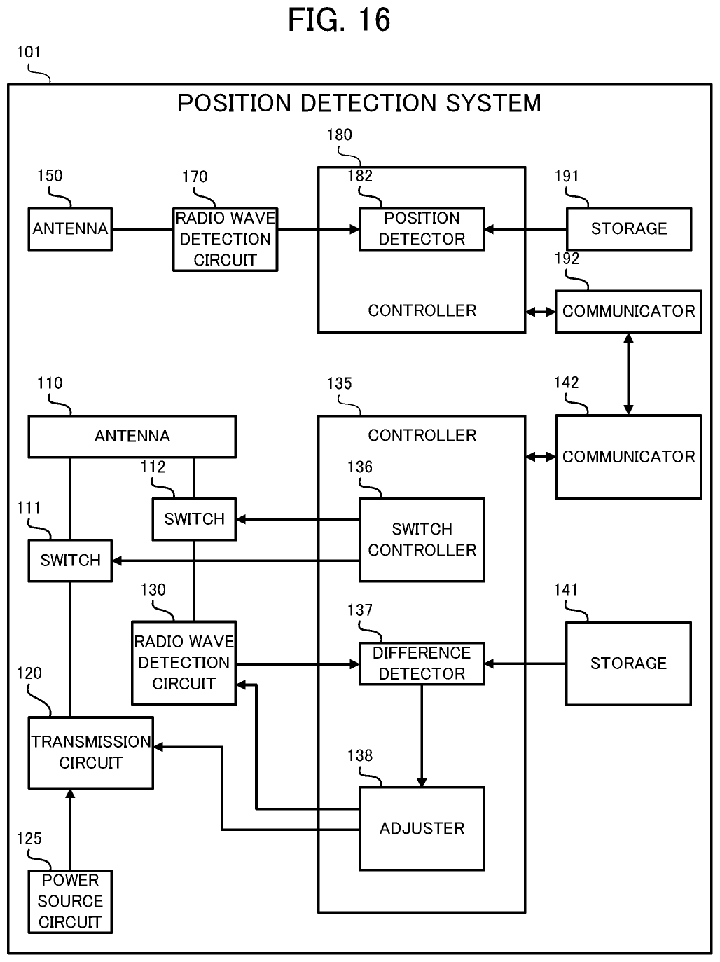

Next, components of the position detection system 101 will be described in detail with reference to FIG. 16. Note that description of a component that has been already described is omitted or simplified. The position detection system 101 includes the antennas 110, the switches 111, the switches 112, the transmission circuit 120, a power source circuit 125, the radio wave detection circuit 130, a controller 135, a storage 141, a communicator 142, the antenna 150, the radio wave detection circuit 170, a controller 180, a storage 191, and a communicator 192.

The antenna 110 emits a radio wave related to a high-frequency signal supplied by the transmission circuit 120. The switch 111 changes the connection between the antenna 110 and the transmission circuit 120. The switch 112 changes the connection between the antenna 110 and the transmission circuit 120. The transmission circuit 120 supplies a high-frequency signal generated from power source voltage to the antenna 110. The power source circuit 125 supplies power source voltage to the transmission circuit 120. The radio wave detection circuit 130 detects intensity of a radio wave received by the antenna 110. The radio wave detection circuit 130 is an example of the second radio wave detection circuit.

The controller 135 controls operation of components placed in a power reception device 300 from among the components included in the position detection system 101. For example, the controller 135 causes the antenna 110 to emit a radio wave by controlling the transmission circuit 120. For example, the controller 135 adjusts the antenna characteristic of the antenna 110, based on intensity detected by the radio wave detection circuit 130. The controller 135 includes a CPU, a ROM, a RAM, an RTC, an A/D converter, and the like. Details of the controller 135 will be described later.

The storage 141 stores various types of information used by the controller 135 or various types of information acquired through operation of the controller 135. For example, the storage 141 stores reference data used for detection of a relative position and reference intensity used for adjustment of an antenna characteristic. For example, the storage 141 includes a flash memory. The communicator 142 communicates with the communicator 192 in accordance with control by the controller 135. The communicator 142 includes a communication interface conforming to a well-known wireless communication standard.

The antenna 150 receives a radio wave emitted by the antenna 110. The radio wave detection circuit 170 detects intensity of a radio wave received by the antenna 150. The radio wave detection circuit 170 is an example of a first radio wave detection circuit. The controller 180 controls operation of components placed in a power transmission device 200 from among the components included in the position detection system 100. The controller 180 functionally includes a position detector 182. The position detector 182 detects a relative position between a power transmission coil 211 and a power reception coil 311, based on intensity detected by the radio wave detection circuit 170. The controller 180 includes a CPU, a ROM, a RAM, an RTC, an A/D converter, and the like.

The storage 191 stores various types of information used by the controller 180 and various types of information acquired through operation of the controller 180. For example, the storage 191 includes a flash memory. The communicator 192 communicates with the communicator 142 in accordance with control by the controller 180. The communicator 192 includes a communication interface conforming to a well-known wireless communication standard, similarly to the communicator 142.

Next, the function of the controller 135 will be described in detail. The controller 135 functionally includes a switch controller 136, a difference detector 137, and an adjuster 138. For example, the functional units included in the controller 135 are provided by the CPU executing an operation program stored in the ROM.

The switch controller 136 controls the switches 111 and the switches 112. The switch controller 136 controls the switches 112 in such a way as to connect the radio wave detection circuit 130 to an antenna 110 other than an antenna 110 connected to the transmission circuit 120 by a switch 111 from among a plurality of antennas 110.

The difference detector 137 detects the difference between intensity of a radio wave received by another antenna 110 and predetermined reference intensity. The another antenna 110 is an antenna 110 other than an antenna 110 driven by the transmission circuit 120 from among the two antennas 110. The antenna 110 driven by the transmission circuit 120 here is the antenna 110A, and the another antenna 110 is the antenna 110B. For example, the reference intensity is intensity of a radio wave being emitted from an antenna 110 placed at the same position as the antenna 110A and being received by an antenna 110 placed at the same position as the antenna 110B when the reference data are acquired. A larger difference detected by the difference detector 137 indicates a larger difference in the antenna characteristic between the time of acquisition of the reference intensity and the time of execution of calibration.

The adjuster 138 adjusts each element in such a way that the difference detected by the difference detector 137 decreases. For example, the adjuster 138 adjusts the frequency characteristic of an LC series resonant circuit including an antenna 110 transmitting a radio wave. For example, the adjuster 138 adjusts the capacitance value of a capacitive element 121 included in the LC series resonant circuit in such a way that the aforementioned difference decreases. Further, the adjuster 138 adjusts a duty ratio in PWM control of the transmission circuit 120 in such a way that the aforementioned difference decreases.

Further, for example, the adjuster 138 adjusts the frequency characteristic of an RLC parallel resonant circuit including an antenna 110 receiving a radio wave. For example, the adjuster 138 adjusts the capacitance value of a capacitive element 131 included in the RLC parallel resonant circuit in such a way that the aforementioned difference decreases. Further, the adjuster 138 adjusts the resistance value of a resistor 132 included in the RLC parallel resonant circuit in such a way that the aforementioned difference decreases.

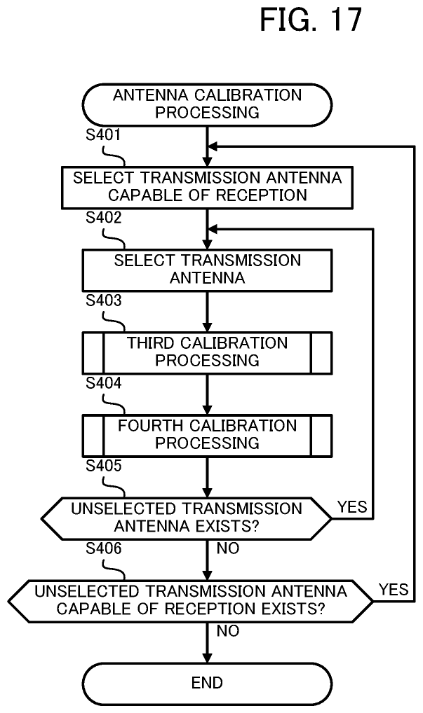

Next, antenna calibration processing executed by the position detection system 101 will be described with reference to FIG. 17. For example, when receiving a start instruction for position detection processing from the power transmission device 200, the position detection system 101 executes the antenna calibration processing prior to the position detection processing.

First, the controller 135 included in the position detection system 101 selects a transmission antenna capable of reception (Step S401). For example, the controller 135 selects either antenna 110 of the antenna 110A and the antenna 110B. When completing the processing in Step S401, the controller 135 selects a transmission antenna (Step S402). For example, the controller 135 selects an antenna 110 other than the antenna 110 selected in Step S401 from among the two antennas 110.

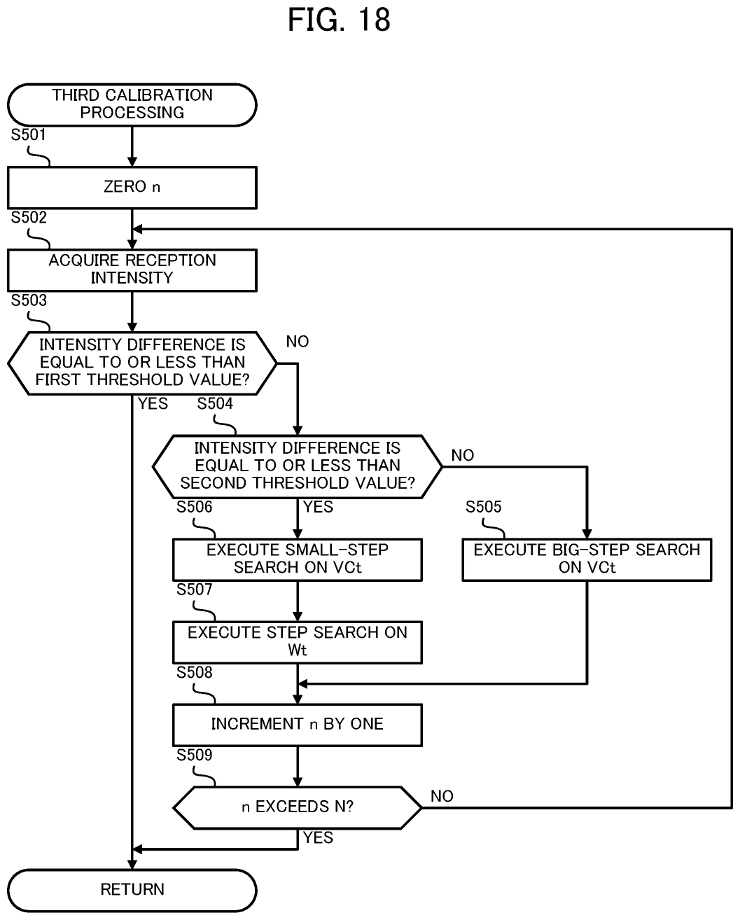

When completing the processing in Step S402, the controller 135 executes third calibration processing (Step S403). The third calibration processing will be described in detail with reference to a flowchart illustrated in FIG. 18. The third calibration processing is processing of adjusting the antenna characteristic of an antenna 110 transmitting a radio wave.

First, the controller 135 zeros n (Step S501). When completing the processing in Step S501, the controller 135 acquires reception intensity (Step S502). For example, the controller 135 causes the antenna 110 selected in Step S402 to emit a radio wave and causes the antenna 110 selected in Step S401 to receive the radio wave. The controller 135 acquires reception intensity being intensity of the radio wave received by the antenna 110 from the radio wave detection circuit 130.

When completing the processing in Step S502, the controller 135 determines whether an intensity difference is equal to or less than a first threshold value (Step S503). The intensity difference is the difference between reference intensity being previously acquired and being stored in the storage 191, and the reception intensity acquired in Step S502. When determining that the intensity difference is not equal to or less than the first threshold value (Step S503: NO), the controller 135 determines whether the intensity difference is equal to or less than a second threshold value (Step S504). When determining that the intensity difference is not equal to or less than the second threshold value (Step S504: NO), the controller 135 executes a big-step search on VCt (Step S505). Specifically, the controller 135 searches for VCt minimizing the intensity difference while adjusting VCt on a per first step width basis.

When determining that the intensity difference is equal to or less than the second threshold value (Step S504: YES), the controller 135 executes a small-step search on VCt (Step S506). Specifically, the controller 135 searches for VCt minimizing the intensity difference while adjusting VCt on a per second step width basis. When completing the processing in Step S506, the controller 135 executes a step search on VRt (Step S507). Specifically, the controller 135 searches for VRt minimizing the intensity difference while adjusting VRt on a per third step width basis.

When completing the processing in Step S505 or Step S507, the controller 135 increments n by one (Step S508). When completing the processing in Step S508, the controller 135 determines whether n exceeds N (Step S509). When determining that n does not exceed N (Step S509: NO), the controller 135 returns the processing to Step S502. When determining that the intensity difference is equal to or less than the first threshold value (Step S503: YES) or determining that n exceeds N (Step S509: YES), the controller 135 completes the third calibration processing.

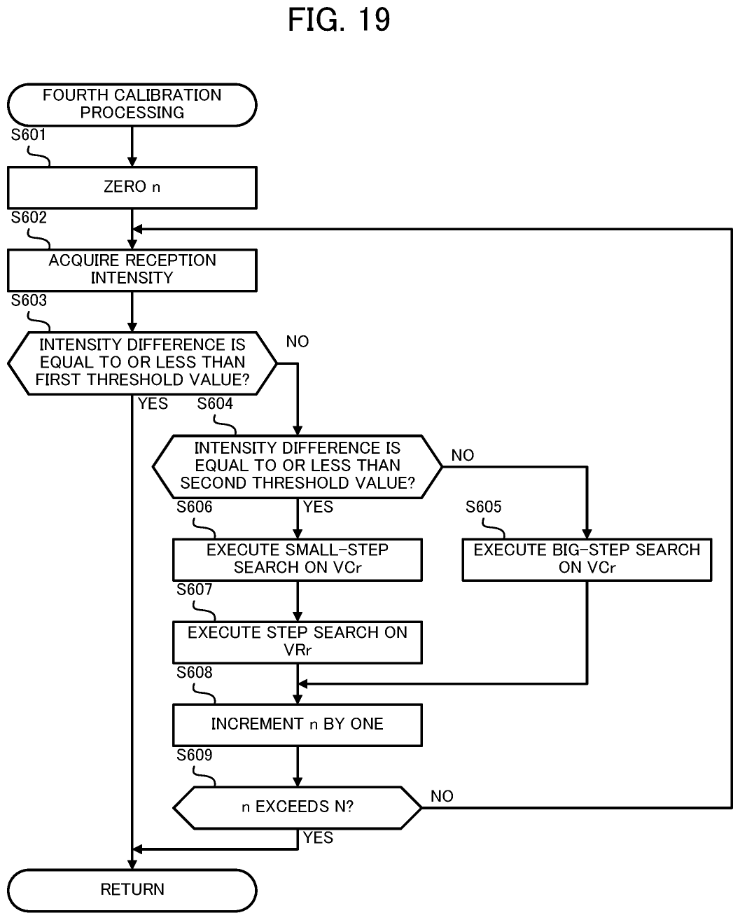

When completing the third calibration processing in Step S403, the controller 135 executes fourth calibration processing (Step S404). The fourth calibration processing will be described in detail with reference to a flowchart illustrated in FIG. 19. The fourth calibration processing is processing of adjusting the antenna characteristic of an antenna 110 receiving a radio wave.

First, the controller 135 zeros n (Step S601). When completing the processing in Step S601, the controller 135 acquires reception intensity (Step S602). When completing the processing in Step S602, the controller 135 determines whether the intensity difference is equal to or less than the first threshold value (Step S603). When determining that the intensity difference is not equal to or less than the first threshold value (Step S603: NO), the controller 135 determines whether the intensity difference is equal to or less than the second threshold value (Step S604). When determining that the intensity difference is not equal to or less than the second threshold value (Step S604: NO), the controller 135 executes a big-step search on VCr (Step S605). When determining that the intensity difference is equal to or less than the second threshold value (Step S604: YES), the controller 135 executes a small-step search on VCr (Step S606). When completing the processing in Step S606, the controller 135 executes a step search on VRr (Step S607).

When completing the processing in Step S605 or Step S607, the controller 135 increments n by one (Step S608). When completing the processing in Step S608, the controller 135 determines whether n exceeds N (Step S609). When determining that n does not exceed N (Step S609: NO), the controller 135 returns the processing to Step S602. When determining that the intensity difference is equal to or less than the first threshold value (Step S603: YES) or determining that n exceeds N (Step S609: YES), the controller 135 completes the fourth calibration processing.

When completing the fourth calibration processing in Step S404, the controller 135 determines whether an unselected transmission antenna exists (Step S405). Specifically, the controller 135 determines whether an antenna 110 being not selected in Step S402 and being an antenna 110 other than the antenna 110 selected in Step S401 from among the two antennas 110 exists. When determining that an unselected transmission antenna exists (Step S405: YES), the controller 135 returns the processing to Step S402 and selects the unselected transmission antenna.

When determining that an unselected transmission antenna does not exist (Step S405: NO), the controller 135 determines whether an unselected transmission antenna capable of reception exists (Step S406). Specifically, the controller 135 determines whether an antenna 110 not selected in Step S401 from among the antenna 110A and the antenna 110B exists. When determining that an unselected transmission antenna capable of reception exists (Step S406: YES), the controller 135 returns the processing to Step S401 and selects the unselected transmission antenna capable of reception. When determining that an unselected transmission antenna capable of reception does not exist (Step S406: NO), the controller 135 completes the antenna calibration processing.

As described above, the radio wave detection circuit 130 detecting intensity of a radio wave received by an antenna 110 being a transmission antenna is provided, and intensity of a radio wave being transmitted from a driven antenna 110 and being received by another antenna 110 is detected by the radio wave detection circuit 130, according to the present embodiment. Accordingly, a basis for determination of whether the antenna characteristic of the antenna 110 transmitting the radio wave is suitable can be acquired, according to the present embodiment. Further, the difference between the intensity of the radio wave received by the another antenna 110 and the predetermined reference intensity is detected, according to the present embodiment. Accordingly, whether the antenna characteristic of the antenna 110 transmitting the radio wave is suitable can be determined, according to the present embodiment.

Further, the frequency characteristic an LC series resonant circuit including an antenna 110 transmitting a radio wave is suitably adjusted by adjustment of the capacitance value of the capacitive element 121 and adjustment of a duty ratio in PWM control, according to the present embodiment. Accordingly, the antenna characteristic of the antenna 110 transmitting the radio wave is suitably adjusted, and a relative position between the power transmission coil 211 and the power reception coil 311 can be precisely detected in wireless electric power transmission, according to the present embodiment.

Further, the frequency characteristic of an RLC parallel resonant circuit including the another antenna 110 is suitably adjusted by adjustment of the capacitance value of the capacitive element 131 and adjustment of the resistance value of the resistor 132, according to the present embodiment. Accordingly, the antenna characteristic of the antenna 110 transmitting a radio wave is precisely adjusted even when the antenna characteristic of the antenna 110 receiving the radio wave changes from that at the time of acquisition of the reference data and the reference intensity, according to the present embodiment.

Further, the radio wave detection circuit 130 according to the present embodiment detects intensity of a radio wave received by two or more antennas 110 from among a plurality of antennas 110. Accordingly, the antenna characteristic of every antenna 110 can be adjusted, according to the present embodiment.

### Modified Examples

While the embodiments of the present disclosure have been described above, modifications and applications in various forms can be made in implementation of the present disclosure. In the present disclosure, any part of the configurations, functions, and operations described in the aforementioned embodiments can be employed. Further, in the present disclosure, further configurations, functions, and operations may be employed in addition to the aforementioned configurations, functions, and operations. Further, the aforementioned embodiments may be combined in any way as appropriate. Further, the number of components described in the aforementioned embodiments may be adjusted as appropriate. Further, it is apparent that materials, sizes, electric characteristics, and the like employable in the present disclosure are not limited to those described in the aforementioned embodiments.

An example of providing the function of transmitting a radio wave for a reception antenna and adjusting the antenna characteristics of reception antennas between the reception antennas has been described in Embodiment 1. Further, an example of providing the function of receiving a radio wave for a transmission antenna and adjusting the antenna characteristics of transmission antennas between the transmission antennas has been described in Embodiment 2. The antenna characteristics of reception antennas may be adjusted between the reception antennas by providing the function of transmitting a radio wave for a reception antenna, and the antenna characteristics of transmission antennas may be adjusted between the transmission antennas by providing the function of receiving a radio wave for a transmission antenna.

An example of automatically adjusting the antenna characteristic of a reception antenna or a transmission antenna when the antenna characteristic differs from a predetermined antenna characteristic has been described in Embodiments 1 and 2. The antenna characteristic of a reception antenna or a transmission antenna may not be adjusted and an error notification may be made when the antenna characteristic differs from the predetermined antenna characteristic.

An example of adjusting a duty ratio in PWM control when adjusting the frequency characteristic of an LC series resonant circuit has been described in Embodiments 1 and 2. Power source voltage of a high-frequency signal in PWM control may be adjusted when adjusting the frequency characteristic of the LC series resonant circuit. In this case, output voltage of the inverter included in the transmission circuit 120 or the transmission circuit 160 is adjusted.

An example of not only adjusting the frequency characteristic of an RLC parallel resonant circuit including a reception antenna receiving a radio wave but also adjusting the frequency characteristic of an LC series resonant circuit including a reception antenna transmitting a radio wave has been described in Embodiment 1. The frequency characteristic of the LC series resonant circuit including the reception antenna transmitting a radio wave may not be adjusted. Further, an example of not only adjusting the frequency characteristic of an LC series resonant circuit including a transmission antenna transmitting a radio wave but also adjusting the frequency characteristic of an RLC parallel resonant circuit including a transmission antenna receiving a radio wave has been described in Embodiment 2. The frequency characteristic of the RLC parallel resonant circuit including the transmission antenna receiving a radio wave may not be adjusted.

An example of placing a reception antenna in the power transmission device 200 and placing a transmission antenna in the power reception device 300 has been described in Embodiments 1 and 2. A transmission antenna may be placed in the power transmission device 200, and a reception antenna may be placed in the power reception device 300.

Applying an operation program defining the operation of the position detection system 100 or 101 according to the present disclosure to a computer such as an existing personal computer or an information terminal device may cause the computer to also function as the position detection system 100 or 101 according to the present disclosure. Further, any method may be employed as a distribution method of such a program, and for example, the program may be stored and distributed in a non-transitory computer-readable recording medium such as a compact disk ROM (CD-ROM), a digital versatile disk (DVD), a magneto optical disk (MO), or a memory card and may be distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A position detection system for an electric power transmission system wirelessly transmitting electric power from a power transmission coil included in a power transmission device to a power reception coil included in a power reception device, the position detection system comprising:
at least one first antenna provided in one device from among the power transmission device and the power reception device;
a first transmission circuit driving the at least one first antenna;
a plurality of second antennas provided in the other device from among the power transmission device and the power reception device;
a radio wave detection circuit detecting intensity of a radio wave received by the plurality of second antennas;
a position detector detecting a relative position between the power transmission coil and the power reception coil, based on the intensity detected by the radio wave detection circuit; and
a second transmission circuit driving at least one second antenna from among the plurality of second antennas,
wherein the radio wave detection circuit detects intensity of a radio wave being transmitted from a second antenna driven by the second transmission circuit from among the plurality of second antennas and being received by another second antenna being a second antenna other than the second antenna driven by the second transmission circuit from among the plurality of second antennas.

2. The position detection system according to claim 1, further comprising:
a difference detector detecting a difference between intensity of a radio wave received by the another second antenna and predetermined reference intensity.

3. The position detection system according to claim 2, further comprising:
a first switch changing a connection between the at least one second antenna from among the plurality of second antennas and the second transmission circuit; and
a second switch changing connections between the plurality of second antennas and the radio wave detection circuit.

4. The position detection system according to claim 3, further comprising:
a switch controller controlling the first switch and the second switch,
wherein the switch controller controls the second switch in such a way as to connect a second antenna other than a second antenna connected to the second transmission circuit by the first switch from among the plurality of second antennas to the radio wave detection circuit.

5. The position detection system according to claim 3, further comprising:
a first capacitive element being connected to the first switch and forming an LC resonant circuit with the second antenna; and
a second capacitive element and a first resistor that are connected to the second switch and form an RLC resonant circuit with the second antenna.

6. The position detection system according to claim 5, wherein
the second capacitive element is a variable capacitance element having a variable capacitance value, and
a capacitance value of the second capacitive element is adjusted in such a way that the difference decreases.

7. The position detection system according to claim 5, wherein
the first resistor is a variable resistance element having a variable resistance value, and
a resistance value of the first resistor is adjusted in such a way that the difference decreases.

8. The position detection system according to claim 5, wherein
the first capacitive element is a variable capacitance element having a variable capacitance value, and
a capacitance value of the first capacitive element is adjusted in such a way that the difference decreases.

9. The position detection system according to claim 2, wherein
the second transmission circuit is PWM controllable, and
a duty ratio is adjusted in PWM control of the second transmission circuit in such a way that the difference decreases.

10. The position detection system according to claim 9, wherein
the first transmission circuit is PWM controllable, and
PWM control of the first transmission circuit is executed at a duty ratio adjusted in PWM control of the second transmission circuit.

11. The position detection system according to claim 1, wherein the second transmission circuit drives two or more second antennas from among the plurality of second antennas.

12. A position detection system for an electric power transmission system wirelessly transmitting electric power from a power transmission coil included in a power transmission device to a power reception coil included in a power reception device, the position detection system comprising:
at least one first antenna provided in one device from among the power transmission device and the power reception device;
a first radio wave detection circuit detecting intensity of a radio wave received by the at least one first antenna;
a plurality of second antennas provided in the other device from among the power transmission device and the power reception device;
a transmission circuit driving the plurality of second antennas;
a position detector detecting a relative position between the power transmission coil and the power reception coil, based on the intensity detected by the first radio wave detection circuit; and
a second radio wave detection circuit detecting intensity of a radio wave received by at least one second antenna from among the plurality of second antennas,
wherein the second radio wave detection circuit detects intensity of a radio wave being transmitted from a second antenna driven by the transmission circuit from among the plurality of second antennas and being received by another second antenna being a second antenna other than the second antenna driven by the second transmission circuit from among the plurality of second antennas.

13. The position detection system according to claim 12, further comprising:
a difference detector detecting a difference between intensity of a radio wave received by the another second antenna and predetermined reference intensity.

14. The position detection system according to claim 13, further comprising:
a first switch changing connections between the plurality of second antennas and the transmission circuit; and
a second switch changing a connection between the at least one second antenna from among the plurality of second antennas and the second radio wave detection circuit.

15. The position detection system according to claim 14, further comprising a switch controller controlling the first switch and the second switch,
wherein the switch controller controls the first switch in such a way as to connect a second antenna other than a second antenna connected to the second radio wave detection circuit by the second switch from among the plurality of second antennas to the transmission circuit.

16. The position detection system according to claim 14, further comprising:
a first capacitive element being connected to the first switch and forming an LC resonant circuit with the second antenna; and
a second capacitive element and a first resistor that are connected to the second switch and form an RLC resonant circuit with the second antenna.

17. The position detection system according to claim 16, wherein
the second capacitive element is a variable capacitance element having a variable capacitance value, and
a capacitance value of the second capacitive element is adjusted in such a way that the difference decreases.

18. The position detection system according to claim 16, wherein
the first resistor is a variable resistance element having a variable resistance value, and
a resistance value of the first resistor is adjusted in such a way that the difference decreases.

19. The position detection system according to claim 16, wherein
the first capacitive element is a variable capacitance element having a variable capacitance value, and
a capacitance value of the first capacitive element is adjusted in such a way that the difference decreases.

20. The position detection system according to claim 13, wherein
the transmission circuit is PWM controllable, and
a duty ratio is adjusted in PWM control of the transmission circuit in such a way that the difference decreases.

21. The position detection system according to claim 12, wherein the second radio wave detection circuit detects intensity of a radio wave received by two or more second antennas from among the plurality of second antennas.

22. An electric power transmission system, comprising:
the position detection system according to claim 1;
a power transmission device including a power transmission coil; and
a power reception device including a power reception coil to which electric power is wirelessly transmitted from the power transmission coil.
